(19) United States
(12) Patent Application Publication
(10) Pub. No.: US 2018/0096167 A1
(43) Pub. Date: Apr. 5, 2018

(54) PERSONAL HEALTH NETWORK

(71) Applicant: University Hospitals Cleveland Medical Center, Cleveland, OH (US)

(72) Inventors: Elizabeth Hammack, Shaker Heights, OH (US); Salvatore Esposito, Bainbridge, OH (US); Seth Wolf, Pepper Pike, OH (US)

(21) Appl. No.: 15/720,976

(22) Filed: Sep. 29, 2017

Related U.S. Application Data
(60) Provisional application No. 62/402,803, filed on Sep. 30, 2016.

(51) Int. Cl. G06F 21/62; G06F 19/00

(52) U.S. Cl. CPC G06F 21/6245; G06Q 10/1095; G06F 19/3406; G06F 19/3456

(57) ABSTRACT

Systems, methods and computer readable media are provided that facilitate establishing a personal health network (PHN). In an embodiment, as system can include an authorization component configured to receive authorization information indentifying one or more entities that a patient authorizes for inclusion in a PHN of the patient. The system can further include an access component configured to provide the one or more entities access to healthcare information regarding healthcare of the patient via respective devices of the one or more entities based on inclusion of the one or more entities in the PHN of the patient, and a connection component configured to facilitate communication between the one or more entities and the patient regarding the healthcare of the patient via the respective devices of the one or more entities and the patient device based on inclusion of the one or more entities in the PHN of the patient.

### CROSS-REFERENCE TO RELATED APPLICATIONS

This application is a U.S. Non-Provisional patent application that claims the benefit of priority to U.S. Provisional Patent Application No. 62/402,803, filed Sep. 30, 2016 and titled “PERSONAL HEALTH NETWORK,” the entirety of which application is hereby incorporated herein by reference.

### TECHNICAL FIELD

This application generally relates to a personal health network (PHN) that connects a patient with a selected group of friends, family, or caregivers to facilitate care of the patient.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates an example personal health network (PHN) system in accordance with various aspects and embodiments described herein;

FIG. 2A presents an example login interface that facilitates logging into a user account and/or creating a user account in accordance with various aspects and embodiments described herein;

FIG. 2B presents an example home screen interface that facilitates accessing various functions of a PHN service provider in accordance with various aspects and embodiments described herein.

FIGS. 3A and 3B present example medical information interfaces in accordance with various aspects and embodiments described herein.

FIG. 4 presents various components that can be included in a server connection component and/or a client connection component of a PHN system in accordance with various embodiments described herein.

FIGS. 5A-B present various example interfaces that demonstrate one or more features and functionalities of the server connection component and/or the client connection component in accordance with various aspects and embodiments described herein.

FIG. 6 presents an example interface that can facilitate sending and receiving private and/or group messages between the patient and one or more members included in the patient's PHN.

FIG. 7 presents an example interface including a wall generated for a patient in association with the patient's PHN in accordance with various embodiments provided herein.

FIG. 8 presents an example interface of a homepage for a member of a patient's PHN in accordance with various aspects and embodiments described herein.

FIG. 9 presents integration of an example appointment management component into a PHN network service provider and/or a PHN application associated with an example PHN system in accordance with various embodiments described herein.

FIGS. 10A-C present example interfaces facilitated by an appointment management component of an example PHN system in accordance with various embodiments described herein.

FIG. 11 presents integration of an example medication management component into a PHN network service provider and/or a PHN application associated with an example PHN system in accordance with various embodiments described herein.

FIGS. 12A-B present example interfaces facilitated by a medication management component of an example PHN system in accordance with various embodiments described herein.

FIG. 13 presents integration of an example safety alert component into a PHN network service provider 102 and/or a PHN application associated with an example PHN system in accordance with various embodiments described herein.

FIGS. 14A-B present example interfaces facilitated by a safety alert component of an example PHN system in accordance with various embodiments described herein.

FIG. 15 presents various additional components that can be provided at a PHN network service provider and/or a PHN application associated with an example PHN system in accordance with various embodiments described herein.

FIG. 16 is a schematic block diagram illustrating a suitable operating environment in accordance with various aspects and embodiments.

FIG. 17 is a schematic block diagram of a sample-computing environment in accordance with various aspects and embodiments.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure is directed to computer processing systems, computer-implemented methods, apparatus and/or computer program products that facilitate generation and usage of a personal health network (PHN) that connects a patient with a selected group of friends, family, or caregivers to facilitate care of the patient. Many patients in the United States have access to a “personal health record,” which allows the patient to view his or her own medical information. However, patients who use most healthcare services do so as part of a group of people that includes family, friends, and/or caregivers who come together to coordinate and manage the patient's care. For example, when a patient becomes ill or after a patient is discharged from the hospital, many people including friends, family and caregivers can become involved in the patient's care, whether it's actively attending to the patient's medical needs or providing emotional support. However, due to various patient privacy concerns, it can be difficult to keep each of the patient's friends, family and/or caregivers informed regarding the patient healthcare, health status and health needs. As a result, coordinating patient visits, patient communication, patient care roles, and patient care responsibilities between the patient's friends, family and caregivers can become very difficult, especially when the patient himself or herself is not well enough to actively manage such activities.

The subject disclosure provides a web-based networking system, referred to herein as a PHN system, which facilitates connecting patients with a select group of friends, family, and/or caregivers to facilitate care of the patient. The web-based networking system can be implemented using an application platform, a website platform, or other suitable network accessible platform that can be accessed by users via their respective personal computing devices (e.g., a smartphone, a tablet personal computer (PC), an laptop PC, a desktop PC, an Internet enabled television, etc.).

In one or more embodiments, the subject PHN system can provide a network based platform (e.g., an application or website) via which a patient can establish a user account or profile and access various types of healthcare information regarding the patient's healthcare. The healthcare information can include information provided by one or more healthcare organizations as well as information received from other sources including individuals included in the patient's PHN (as described below) and/or information received from a health monitoring device employed by the patient (e.g., a wearable device, an implanted device, and the like). For example, using the subject PHN system, after the patient logs into the patient's security protected user account, the patient can access his or her personal health record as well as other information related to the patient's care and diagnosis, such as but not limited to: information regarding the patient's upcoming appointments, information regarding the patient's medication regimen, information regarding the patient's monitored health status, information regarding the patient's care plan, informative information regarding the patient's diagnosis, and the like.

In addition to providing the patient access to personal healthcare information associated with the patient, the subject PHN system allows the patient to select one or more entities (e.g., friends, family, and/or caregivers) to be included in the patient's PHN who can also access the patient's healthcare information (or select portions thereof). The term PHN is used herein to refer to the group of friends, family, and/or caregivers that a patient has selected and authorized to have access to information regarding the patient's healthcare and/or to participate in the patient's healthcare. Once a patient has added individuals to the patient's PHN, the respective individuals can also establish security protected user accounts with the PHN system and access information regarding the patient's healthcare. For example, a fictional patient, referred to herein as John Doe, can include an 85 year old man who lives in an assisted living facility in the Cleveland area. Using the subject PHN system, John Doe may select the following people to be part of his PHN: (1) his son, who also lives in the Cleveland area; (2) his daughter, who lives out of state; (3) his best friend, who lives in the Cleveland area; and (4) his assisted living nurse, who participates in his care at his assisted living facility. In various embodiments, by affirmatively selecting individuals to be part of a patient's PHN, the patient authorizes each of the individuals to receive healthcare information in a manner that is compliant with existing health care regulations (e.g., compliant with the Health Insurance Portability and Accountability Act (HIPAA) and the like).

Furthermore, the subject PHN system can provide various additional interactive services that facilitate connecting the patient and the individuals included in the patient's PHN in association with managing the patient's healthcare needs, providing care to the patient, monitoring the patient's health, or otherwise being involved in the patient's healthcare. For example, these additional services can facilitate group dissemination of information regarding the patient's healthcare. The information can include information provided by a healthcare system or entity (e.g., a hospital, an assisted living facility, a physician, a nurse, etc.) as well as information provided by the patient and/or individual's included in the patient's PHN. For example, using the PHN system, an individual included in John Doe's PHN, the patient's son Jonathan Doe for instance, can post information that is accessible to the other members of John Doe's PHN indicating that he just visited John Doe at his assisted living facility and that John Doe was doing exceptionally well, walking about much more this week than last week. These additional services can also includes messaging services that facilitate private and group messaging regarding the patient's healthcare between the patient and one or more individuals included in the patient's PHN. In another example, these additional services can facilitate managing the patient's appointments, coordinating patient care responsibilities for respective individuals included in the patient's PHN, coordinating patient visits, monitoring the patient's medication intake, monitoring the patient's health status, appropriately disseminating private patient information, sending gifts, encouraging patient well being and moral, and the like.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

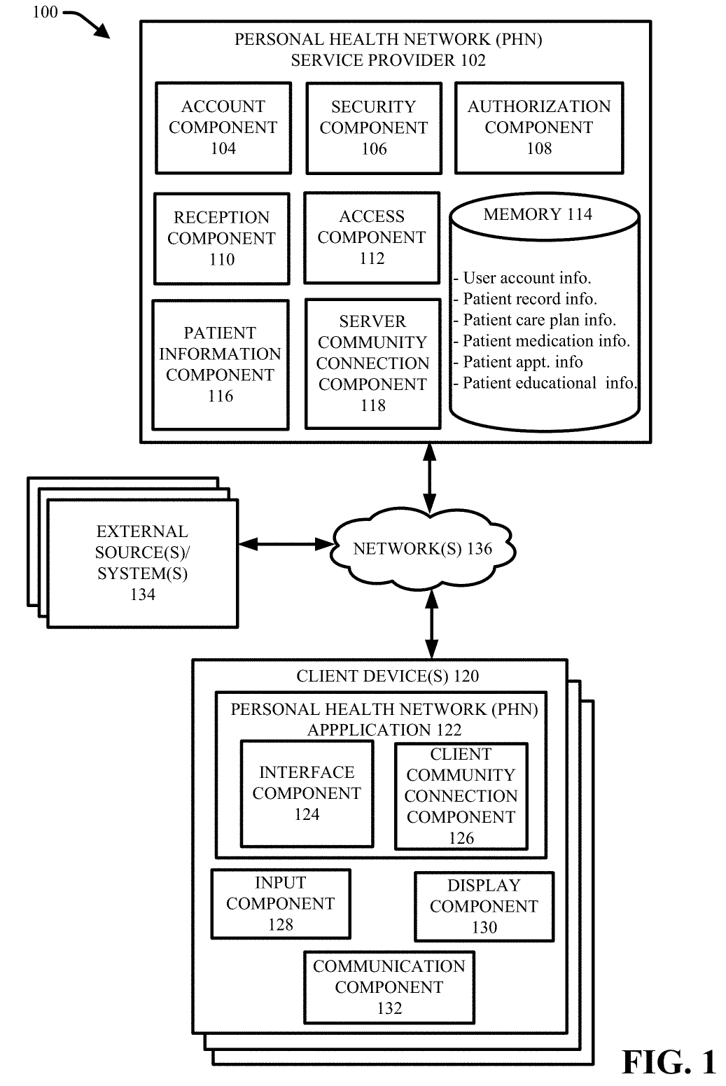

Referring now to the drawings, with reference initially to FIG. 1, presented is a high level block diagram of an example PHN system 100 that connects a patient with a selected group of friends, family, or caregivers to facilitate care of the patient in accordance with aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

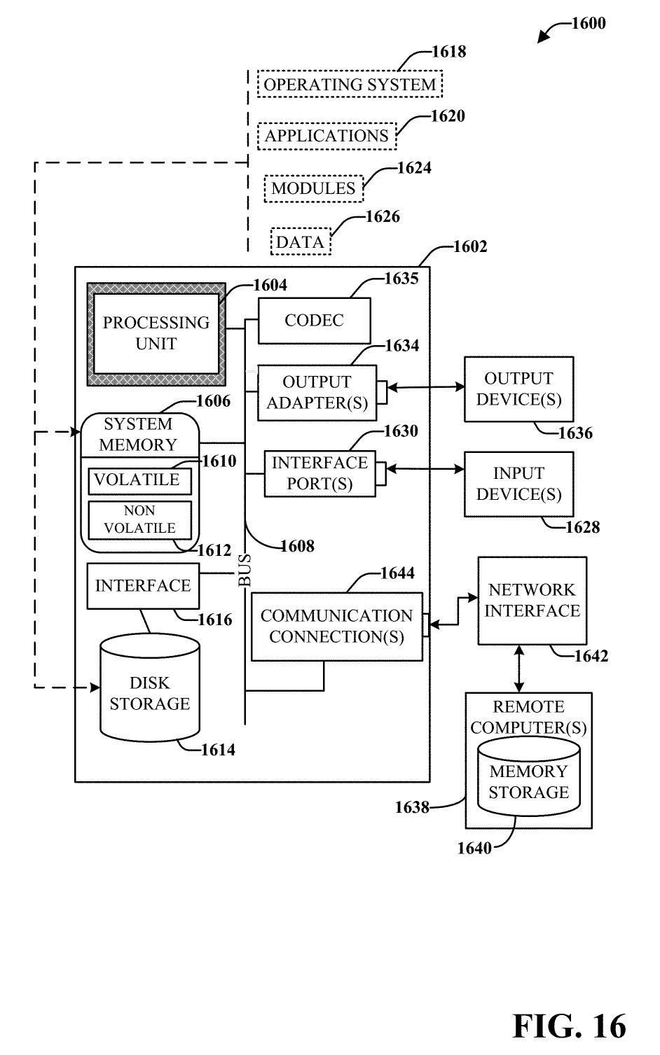

PHN system 100 can include personal health network (PHN) service provider 102, one or more client devices 120, and one or more external sources/systems 134. The PHN service provider 102 and the one or more client devices can respectively comprise at least one processor and at least one memory that stores executable instructions that, when executed by the processor, facilitate performance of operations. For example, with respect to the PHN service provider 102, these components can include but are not limited to: account component 104, security component 106, authorization component 108, reception component 110, access component 112, patient information component 116, and server community connection component 118. In another example, with respect to the one or more client devices 120, these components can include but are not limited to: components of a PHN application 122 provided on the client device, including interface component 124 and client community connection component 126. In some embodiments, software features and functionalities of input component 128, display component 130 and communication component 132 can also be stored in memory of the client device 120 and executed by a processor of the client device. Examples of said processors and memories, as well as other suitable computer or computing-based elements, can be found with reference to FIG. 16, and can be used in connection with implementing one or more of the systems or components shown and described in connection with FIG. 1 or other figures disclosed herein.

The PHN service provider 102 can include an entity configured to provide various healthcare related content and/or PHN services to users (e.g., patient's and individuals included in a patient's PHN) via their respective client devices 120 over a network 136 (e.g., the Internet). For example, the PHN service provider 102 can facilitate generation and operation of a web-based PHN that facilitates connecting patients with a select group of friends, family, and/or caregivers to facilitate care of the patient. The web-based networking system can be implemented using a computing platform that facilitates communication can coordinated processing of information shared between a plurality of devices (e.g., client devices) and external sources/systems 134, such as an application platform (e.g., a thin client application based platform, a thick client based application platform, a web client application based platform, etc.), a website platform, or other suitable network platform.

In accordance with one or more embodiments, the PHN service provider 102 and the one or more client device 120 can be configured to operate in client/server relationship, wherein the PHN service provider 102 provides the one or more client devices 120 access to information and services provided by the PHN service provider 102 via a network accessible platform using a thin client application, a browser or the like. For example, in the embodiment shown, the client devices 120 can respectively include a PHN application 122 that is configured to facilitate accessing and employing the PHN information and services provided by the PHN service provider 102. According to this embodiment, the PHN application 122 can interface component 124 to generate interfaces that facilitate accessing and employing the information and services provided by the PHN service provider 102. The PHN application 122 can also include one or more additional client side components (e.g., client community connection component 126) that are configured to perform/execute one or more logic functions associated with one or more services provided by the PHN service provider 102.

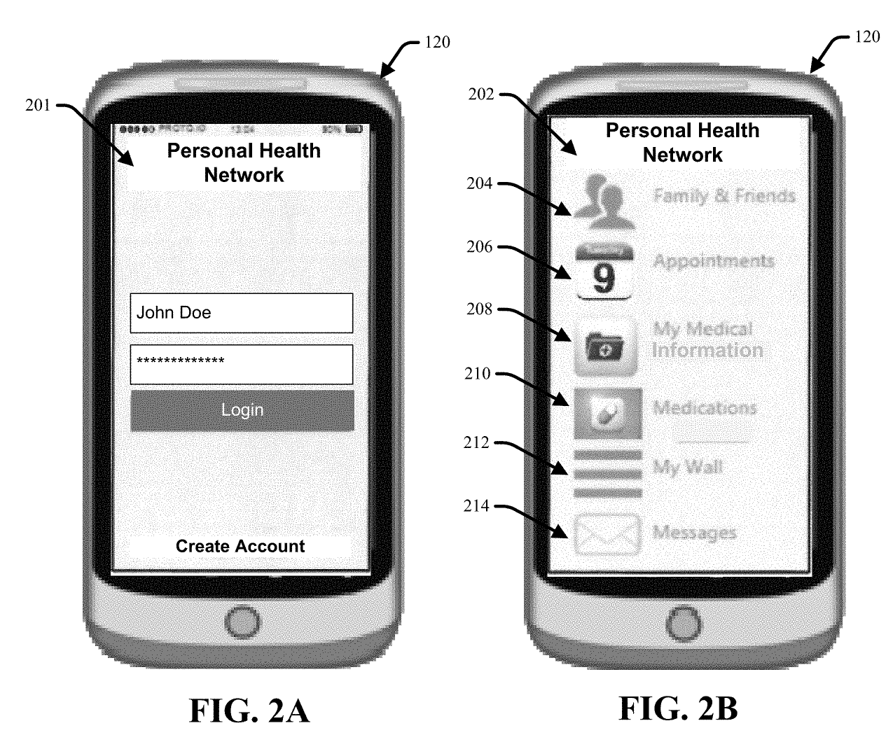

It should be appreciated however that system 100 is not limited to this architectural configuration. For example, in some embodiments, one or more components of the PHN service provider 102 presented in system 100 and described in additional FIGS. 2A-17 can be provided on a client device 120 (e.g., in association with the PHN application 122 or in addition to the PHN application 122) and vice versa. In some embodiments, the PHN service provider and/or one or more components of the PHN service provider 102 is included in a cloud-computing network. “Cloud computing” is a kind of network-based computing that provides shared processing resources and data to computers and other devices on-demand via a network (e.g., one or more networks 136). It is a model for enabling ubiquitous, on-demand access to a shared pool of configurable computing resources (e.g., networks, servers, storage, applications and services), which can be rapidly provisioned and released with minimal management effort. Cloud computing and storage solutions provide users and enterprises with various capabilities to store and process their data in third-party data centers.

The various devices, systems/sources, and components of system 100 can be connected either directly or via one or more networks 136. Such network(s) can include wired and wireless networks, including but not limited to, a cellular network, a wide area network (WAN, e.g., the Internet), a local area network (LAN), or a personal area network (PAN). For example, a client device 120 can communicate with PHN service provider 102 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks.

The one or more client device 120 can include any suitable computing device associated with a user and configured to facilitate accessing and employing the information and services provided by the PHN service provider 102. For example, the one or more client device 424 can include a desktop computer, a laptop computer, a television, an Internet enabled television, a mobile phone, a smartphone, a tablet personal computer (PC), a personal digital assistant PDA, a heads-up display (HUD), virtual reality (VR) headset, augmented reality (AR) headset, or another type of wearable computing device.

In addition to the PHN application 122, the respective client devices 120 can include suitable hardware and software that facilitates receiving and interpreting user input, displaying or rendering information, and communicating with other devices (e.g., the PHN service provider 102, client devices 120, external sources/systems 134, and the like). For example, the respective client devices 120 can include an input component 128 to facilitate receiving and interpreting user input. The input component 128 can include various suitable input hardware, including but not limited to: a touchscreen, hard or soft buttons, a keyboard, a keypad, a mouse, a joystick, voice input, motion/gesture input, image input and the like. The respective client devices 120 can include a display component 130 that is configured to display various types of data including text, media, and rich media and the like (e.g., via a graphical interface (GUI) rendered on a display screen or other suitable medium). The respective client devices 120 can also include a communication component 132 configured with suitable communication hardware and software (e.g., a central processing unit (CPU), a transmitter, a receiver, a transceiver, a decoder/encoder, etc.) to facilitate wired or wireless communication between the client device 120 and other devices (e.g., the PHN service provider 102, the respective client devices 120, and other external devices).

As used in this disclosure, the terms “user,” “patient,” “individual,” “friend,” “family member,” caregiver and the like refer to a person, entity, system, or combination thereof that interfaces with system 100 (or additional systems described in this disclosure) using a client device 120 or another suitable computing device. In addition, the term “patient” is used throughout the subject disclosure to refer to the primary user for which a PHN network is based. In various implementations, the primary user is a referred to as a “patient” because that user is receiving medical treatment and/or has a medical or health related condition for which the user's PHN is developed to assist with. However, various aspects of system 100 and the like are not limited to usage of a PHN to aide with care of a person that is a patient per se. For example, any user that has physical and/or mental health related concerns or goals can employ a system 100 to establish a network of friends, family and/or caregivers to aid and encourage the user with respect to managing their health concerns and achieving their health related goals.

In one or more embodiments, the PHN service provider 102 can include account component 104 to facilitate establishing user accounts with the PHN service provider 102. For example, the account component 104 can allow patients and other suitable users that desire a PHN to initially access the PHN service provide using their respective client devices 120 and register with the PHN service provider 102 to establish a user account with the PHN service provider 102. For instance, in order to establish a user account, the patient can set up a profile or account name (e.g., username) and account access information (e.g., password). The account component 104 can also receive (e.g., from the patient or automatically) contact information for patient via which the patient can be contacted electronically (e.g., email address, a phone number for the patient's client device 120, an identifier for the patient's client device 120, etc.). The information received by the account component 104 in association with establishing a patient account can further be stored by the PHN service provider 102 (e.g., in memory 114 as “user account information”).

In various embodiments, after a patient (or other suitable user) has established a user account with the PHN service provider 102, the patient can receive access to various types of information and services provided by the PHN service provider 102 as described in (greater detail infra). These services include generation of PHN using the PHN service provider 102. The PHN system 100 can provide various additional services based on establishment of a PHN for a patient. In particular, as described above, a PHN can include a group (e.g., one or more) of individuals (e.g., friends, family, caregivers, etc.) that the patient has chosen to be included in the patient's PHN. In various embodiments, inclusion in a patient's PHN provides the respective individuals access to information regarding the patient's healthcare (e.g., referred to herein as “patient healthcare information”), facilitates communication between the patient and the respective individuals regarding the patient's healthcare, and enables usage of various services provided by the PHN service provider 102 that facilitate involvement of the respective individuals in the patient's healthcare.

In some implementations, in order to establish a PHN, the account component 104 can require the individuals that a patient wants to be included in his or her PHN to also establish user accounts with the PHN service provider 102. According to these implementations, after the respective individuals have accessed the PHN service provided using their respective client devices 120 and established user accounts (e.g., using account component 104) with the PHN service provider 102, the account component 104 can link the patient's account and the user accounts for the respective individual such that the patient and the other individuals form a PHN. In one or more implementations, the other users can establish accounts with the PHN service provider 102 using a same or similar mechanism as the patient (e.g., setting up a username and password and providing electronic contact information). User account information for all individuals having accounts with the PHN service provider (e.g., username, password, contact information, and various additional types of user information) can also be stored by the PHN service provider 102 (e.g., in memory 114).

The PHN service provider 102 can employ various mechanisms to facilitate having the individuals a patient wants to include in his or her PHN establish user accounts with the PHN and join the patient's PHN. For example, in some embodiments, using the account component 104, the patient can send electronic message requests (e.g., via email, SMS text message, or another suitable message) to the individuals inviting them to establish accounts with the PHN service provider 102 and join the patient's PHN. In other embodiments, patient can instruct (e.g., in person, on the phone, via a personal message, via an intermediary, etc.) the individuals to establish accounts with the PHN service provider 102. Still in other embodiments, the other individuals may already have accounts with the PHN service provider 102. Once the other individuals have established accounts with the PHN service provider 102 (e.g., using the account component 104), the patient can send a request to the respective individuals (or vice versa) via their established user accounts inviting them to join the patient's PHN. In some embodiments, individuals included in a patient's PHN do not need to establish user accounts with the PHN service provider 102. For example, the individuals can receive information associated without belonging to the PHN service provider 102 (e.g., via an electronic message such as an email, a text, a notification, a phone call, and the like). According to these embodiments, in order to add such an individual to a patient's user account, the patient can merely provide information identifying the individual and including appropriate contact information for the individual (e.g., email address, phone number, client device identifier, etc.)

It should be appreciated that in many scenarios, a patient may not be able (e.g., due to physical and/or mental conditions affecting the patient) to set up a user account and/or perform various functions associated with employing PHN system 100. Accordingly, in various embodiments, the patient can provide another entity authorization to (e.g., the patient's caregiver, friend, family member, etc.,) to assist the patient in association establishing a user account with PHN service provider and establishing a PHN using the PHN service provider 102.

The security component 106 can provide suitable security mechanisms associated with establishing user accounts with the PHN service provider 102 by a patient and other individuals included in the patient's PHN network. For example, the security component 106 can facilitate establishing security information (username and password information) for the respective user accounts and controlling access by the patient and the other individuals to their respective accounts using the security information.

In various embodiments, after a patient has established a user account, the access component 112 can provide the patient access to various types of information associated with the healthcare of the patient, referred to herein collectively as “patient healthcare information.” In one or more embodiments, the reception component 110 can receive such patient healthcare information from various sources, including but not limited to, one or more external sources/systems 134, a medical monitoring device employed by the patient (not shown), a medical professional associated with the patient, (e.g., a medical professional treating the patient), and/or the patient or a legal medical representative of the patient directly. In some embodiments, such patient healthcare information received by the reception component 110 can be collated by the PHN service provider 102 (e.g., via patient information component 116) and associated with the patient's user account by the account component 104. The patient can further view and access the collated patient healthcare information in association with accessing the patient's user account. For example, the PHN service provider 102 can store the patient healthcare information (e.g., in memory 114), and the access component 112 can make the information accessible to the patient via the patient's user account. In other embodiments, such information can be stored by the one or more external sources/systems 134 and the access component 112 can provide the patient healthcare information to the patient on demand in association with the accessing the PHN service provider 102 via the patients user account (e.g., via access component 112).

In one or more embodiments, the patient healthcare information received by the reception component 110 can include information regarding the patient's personal medical health history/record. For example, information associated with a patient's medical health history/record can include but is not limited to: prior diagnosis information, patient examination reports, patient treatment information (e.g., including procedures, care plans, medication regimens etc.), patient test information, patient physical therapy information, patient imaging reports, patient laboratory reports, patient medication information, patient mental health information, patient disease information, patient addiction information, patient surgical reports, patient hospital records, patient developmental disability information, patient allergy records, patient drug abuse records, and the like. The personal patient healthcare information can also include information regarding patient billing and insurance provider. The reception component 110 can also receive patient healthcare information regarding current patient diagnosis information, current patient care plan information (including health care events that are scheduled to occur or have recently occurred), current patient medication information, current patient appointment information and the like.

In some embodiments, the PHN service provider 102 can also receive and associate various types of educational information with a patient account that facilitates informing the patient (and the patient's PHN group members) regarding the patient's current diagnosis, upcoming procedure, care plan and the like. For example, such education information can include documents, articles, videos, etc. (or links to such documents, articles, videos, etc.) associated with informing the patient (and/or the patients PHN group members) regarding the patients current diagnosis, upcoming procedure, care plan and the like (e.g., what it is, what to expect, what are the treatment options, what is the care plan and why, etc.)

In certain exemplary embodiments, the various types of personal healthcare information described above can be automatically provided to the PHN service provider 102 by one or more external sources/systems 134 associated with healthcare service providers from which a patient received healthcares services and/or is receiving healthcare services. For example, such health care service providers can include but are not limited to: health care organizations, health care systems, hospital networks, hospitals, nursing homes, assisted living facilities, physical therapy organizations, pharmacies, etc. For instance, the one or more external sources/systems 134 can include healthcare service providers that have various types of patient information (e.g., medical records) stored in one or more databases for patients to which they rendered healthcare service. According to this example, the PHN service provider 102 can be granted access to such patient information for providing to the respective patients having using accounts with the PHN service provider 102.

In other embodiments, various types of patient healthcare information can be provided to the PHN service provider 102 directly by one or more medical health care professionals that care for the patient (e.g., including physicians, nurses, nurse practitioners, etc). In various additional implementations, in association with establishing a user account, the patient or a representative of the can patient can also provide account information for the patient that includes information regarding the patient's healthcare (e.g., as “patient record information,” “patient diagnosis information,” “patient care plan information,” patient medication information,” “patient appointment information,” etc.) that may or may not be associated with healthcare that the patient is receiving and/or has previously received from an authorized healthcare service provider. The account component 104 can further associate such personal patient healthcare information with the patient's user account/profile. For example, the patient or a representative of the patient can provide personal medical health information that for the patient that the patient or representative of the patient knows about (and would like other individuals on the patient's PHN to know about) that is not included in a network accessible database associated with an external healthcare service provider (e.g., one or more external sources/systems).

In some aspects, patient healthcare information can further include physiological data associated with a patient captured via one or more medical monitoring devices employed by the patient. Such medical monitoring devices can include various types of devices that are worn by or implanted within the patient and configured to capture various biometric measurements that can be sent to and PHN service provider 102 (e.g., in real-time or substantially real-time). Such biometric measurements can be correlated to one or more health states of a patient. For example, such biometric measurement can include information regarding a patient's heart rate, respiratory rate, blood pressure level, glucose level, etc.

In certain implementations, the PHN service provider 102 can include patient information component 116 to facilitate identifying, gathering, and/or collating/indexing patient healthcare information (e.g., as “patient record information,” “patient diagnosis information,” “patient care plan information,” patient medication information,” “patient appointment information,” etc.) for provision (e.g., via access component 112) to a patient (and the patient's PHN members as described below) for respective patients that establish user accounts with PHN service provider 102. For example, in various implementations, based on establishing a user account with the PHN service provider 102, the patient information component 116 can employ information uniquely identifying the patient (e.g., patient name, identifier, etc.) and the one or more external sources/systems 134 for existing healthcare information for the patient. In some embodiments, the patient information component 116 can further retrieve identified relevant patient healthcare information provided by the one or more external sources/systems 134 and for association with the patient's user account. The access component 112 can further provide the patient access to the information in association with access of the patient's user account. In other embodiments, the patient information component 116 can store information with a patient's user account identifying where the relevant patient healthcare information is provided. With theses embodiments, the access component 112 can retrieve the relevant patient healthcare information for provision to the patient upon request.

In one or more embodiments in which the patient is receiving healthcare from one or more healthcare service providers the patient information component 116 can be configured to regularly (e.g., hourly, daily, weekly, etc.) scan one or more external sources/systems (e.g., healthcare service provider systems/sources) to identify new information regarding a patient's healthcare based on establishment of a user account by the patient with the PHN service provider 102. For example, the patient information component 116 can identify new information regarding the patient's progress, laboratory results, procedure results, patient's health care plan events, appointments, newly scheduled procedures, patient discharge, etc. The patient information component 116 can further update a patient's user account with the new information. Similarly, the patient information component 116 can regularly receive physiological/biometric data from one or more medical monitoring devices employed by a patient (e.g., an implantable medical device (IMD), a wearable medical monitoring device, etc.). The patient information component 116 can further update a patient's account with information regarding the received physiological/biometric data and/or health state information determine based on the received physiological/biometric data.

In various embodiments, the authorization component 108 can facilitate authorizing and providing a patient access to the patient's personal healthcare information described above. In particular, much of the patient healthcare information described above that the PHN service provider 102 is capable of receiving and/or accessing for a patient is highly sensitive and dissemination of such personal patient healthcare information is highly regulated (e.g., via HIPAA and the like). Accordingly authorization component 108 can employ extra precautionary measures (e.g., in addition to the mechanism employed by security component 106 to establish and control access to user accounts) to authenticate a patient that has established a user account with the PHN service provider prior to granting the patient access to his or her personal health information. For example, the authorization component 108 can employ a suitable authentication and authorization security check (e.g., in addition to the mechanism employed by security component 106 to establish and control access to user accounts) commensurate with existing healthcare dissemination regulations to determine whether the patient is authorized to access his or her personal healthcare information before providing access to such information.

The authorization component 108 can further provide and/or enforce one or more suitable authentication/authorization mechanisms associated with allowing one or more selected (e.g., by the patient) individuals to join a patient's PHN network. In particular, in one or more embodiments, in addition to employing PHN service provider 102 to receive personal patient healthcare information, as described above, a patient can employ the PHN service provider 102 to establish a PHN via which the patient can provide his or her patient's friends, family, caregivers, etc. (e.g., the entities included in the patient's PHN) efficient and on-demand access to the patient's personal healthcare information. For example, in some implementation, once an individual is included in a patient's PHN, the access component 112 can provide the individual access to the patient's user account and/or associated personal health information. For instance, the access component 112 can allow the individual to view the patient's personal healthcare information via a profile page established for the patient or via another suitable rendering mechanism. The PHN service provider 102 can further provide various additional services to users that are included in a patient's PHN that include interacting and communicating with the patient and/or the one or more other individuals included in the patient's PHN and becoming involved in the patient's care (as described infra). These services can therefore have a significant impact on the patient's well being and overall healthcare while further opening up the respective group members to new and current information regarding the patient's personal healthcare information.

Accordingly, the authorization component 108 can further provide one or more suitable authentication/authorization measures to ensure that individuals who become part of a patient's PHN are expressly authorized to do so in accordance with existing healthcare information dissemination regulations (e.g., HIPAA). In particular, according to various existing healthcare information dissemination, only a patient or an authorized representative of the patient (e.g., legal medical representative or the like) can authorize disclosure of the patient's personal health information to external parties. Accordingly, prior to granting individuals other than a patient or the patient's legal medical representative access to a patient's personal healthcare information and other healthcare services afforded by the PHN service provider 102 in association with inclusion in a patient's PHN, the authorization component 108 can employ one or more suitable security measures to ensure the patient (or the patient's legal representative) authorizes that individual to become part of the patient's PHN.

In some embodiments, such authorization can be based on sending an invitation, by the patient from the patient's user account, to a selected individual requesting the individual to join the patient's PHN. For example, in association with sending a request to an individual inviting the individual to join the patient's PHN, the patient (or the patient's representative) can affirm that the patient authorizes the individual access to the patient's personal medical health information upon acceptance of the invitation. In a similar embodiment, such authorization can be based on acceptance, by the patient via the patient's user account, of a request received from an individual to join the patient's PHN. In other embodiments, in addition to inviting an individual to join the patient's PHN or accepting a request from the individual to join the patient's PHN, the authorization component 108 can employ various additional mechanisms to ensure the patient clearly and definitively authorizes the individual to join the patient's PHN and receive access to the patient's personal health information and the other interactive health care services provide by the PHN service provider. For example, prior to allowing an individual to join the patient's PHN, the authorization component 108 can require the patient to provide additional verification that the patient authorizes the user to join the patient's PHN and that the patient understands and accepts the extent to which the allowing the individual to join the patient's PHN discloses personal healthcare information for the patient and allows the individual to be involved in the patient's healthcare (e.g., via selection of “an agreement to the terms and conditions,” icon in association with input of the patient's signature, a secret key, a password, etc.).

In one or more embodiments, the authorization component 108 can also facilitate authorizing different members of a patient's PHN different levels of access to the patient's personal health information based on the type and/or classification of the information. For example, using the authorization component 108, the patient may restrict access of some members to certain content of the patient's personal health information classified as highly sensitive and while allowing other members access to such information. The authorization component 108 can similarly facilitate providing different levels of access to other information and controlling usage of other services provided by PHN system 100 based on various characteristics of the respective members of the patient's PHN. For example, as described infra, using authorization component 108, the patient can authorize certain selected individuals (e.g., highly trusted or qualified individual) access to particularly sensitive information and/or invasive services afforded by the PHN service provider 102 while restricting access of such sensitive information and usage of such invasive services by other members.

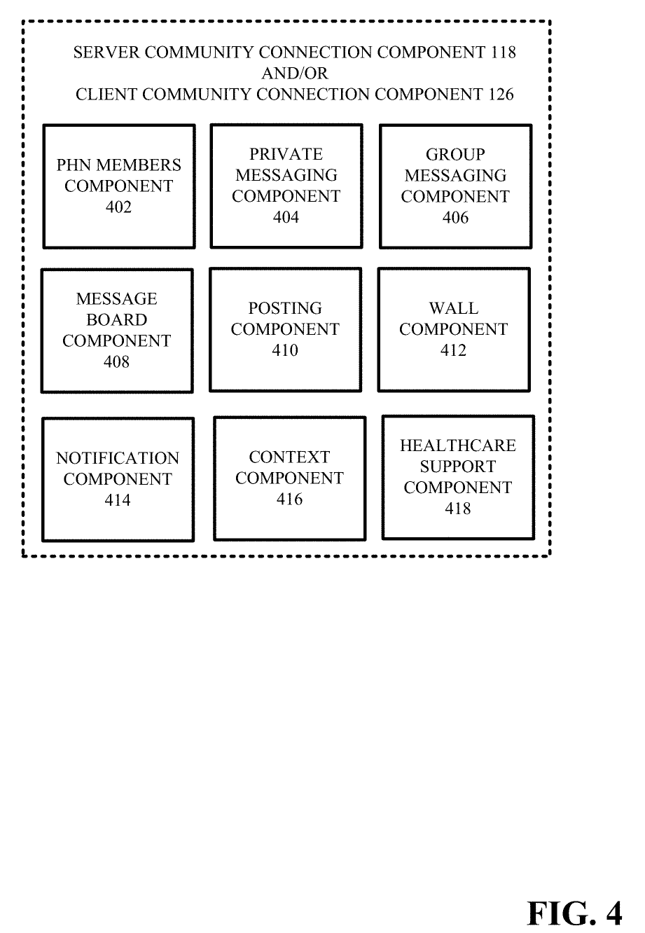

As noted above, in addition to providing authorized individuals included in a patient's PHN access to information regarding the patient's healthcare, the subject PHN system 100 can provide various additional interactive services that facilitate connecting the patient and the individuals included in the patient's PHN in association with managing the patient's healthcare needs, providing care to the patient, managing the patient's appointments, coordinating patient care responsibilities for respective individuals included in the patient's PHN, coordinating patient visits, monitoring the patient's medication intake, monitoring the patient's health status, appropriately disseminating private patient information, sending gifts, encouraging patient well being and moral, and the like. The various additional services provided by the PHN service provider are discussed in greater detail with reference to FIGS. 4-15.

In one or more embodiments, the PHN service provider 102 can include server community connection component 118 to facilitate at least some of the services provided by the PHN service provider 102 described above. For example, the server community connection component 118 can facilitate various type of communication between a patient and respective individuals included in the patient's PHN. The server community connection component 118 can provide various mechanisms via which individuals included in a patient's PHN can receive and communicate information with one another and the patient regarding the patient's ongoing healthcare in an efficient manner. For example, in various embodiments, the server community connection component 118 can facilitate group dissemination of patient healthcare information received by the reception component 110 from various sources, including but not limited to: the one or more external sources/systems 134, medical professional providing care to the patient, a medical monitoring device employed by the patient, and/or the patient (or the patient's representative) himself/herself. In addition to patient healthcare information received from the affirmation sources, the server community connection component 118 can further facilitate group dissemination of information regarding the patient's healthcare received directly from one or more individuals included in the patient's PHN. In other embodiments, the server community connection component 118 can provide various messaging services that facilitate private and group messaging regarding the patient's healthcare between the patient and one or more individuals included in the patient's PHN.

In the embodiment shown, the PHN applications 122 include a client community connection component 126. In various embodiments, the client community connection component 126 can include one or more features and functionalities associated with operations of the server community connection component 118. For example, in one or more embodiments, one or more features and functionalities associated with facilitating various types of communication between a patient and respective individuals included in the patient's PHN can be distributed between the PHN service provider and the PHN application 122. Accordingly, in the embodiment shown, the PHN service provider 102 can include as a server side community connection component that can be configured to perform one or more server side functions associated with facilitating communication between a patient and respective individuals included in the patient's PHN, and the PHN application 122 can include a corresponding client side community connection component to perform one or more client side functions associated with facilitating communication between a patient and respective individuals included in the patient's PHN. Various additional features and functionalities of the server community connection component 118 and the client community connection component 126 are described infra with reference to FIG. 4.

With reference now to FIG. 2A presented is an example login interface 201 presented on a display (e.g., via display component 130) of a client device (e.g., client device 120) that facilitates logging into a user account and/or creating a user account with a PHN service provider (e.g., PHN service provider 102) in accordance with various aspects and embodiments described herein. In the embodiment, shown, the client device 120 is tablet PC or smartphone having a display screen with dimensions commensurate with such devices. However, it should be appreciated that login interface 201 and other interfaces presented herein can be rendered by various types of devices via various types of displays (e.g., a desktop PC, an Internet enabled television, a HUD, etc.).

In one or more embodiments, the login interface 201 (and other interfaces described herein) can be generated at the client device 120 using the interface component 124 in association with employment of the PHN application 122 provided on the client device 120. In other embodiments, login interface 201 (and other interfaces described herein) can be generated using a browser provided on the client device 120 in association with access of a website provided by the PHN service provider 102. The login interface 201 includes username and password information entered by the user which in this case is John Doe, an example patient for which a user account and PHN was previously generated by the patient in accordance with various aspects and embodiments described herein (e.g., via account component 104, security component 106 and authorization component 108). In a scenario in which a new user (e.g., a new patient or individual who wants to join a patient's PHN), opens the PHN application 122 and/or accesses the PHN service provider's 102 website for the first time, the new user can be prompted to select the “create account” icon at the bottom of the screen to go through the process of creating a user account.

FIG. 2B presents an example home screen interface 202 presented on a display (e.g., via display component 130) of a client device (e.g., client device 120) that facilitates accessing various functions of the PHN service provider 102 in accordance with various aspects and embodiments described herein. Repetitive description of like elements employed in respective embodiments is omitted for sake of brevity.

In one or more embodiments, the example home screen interface 202 can be generated and rendered (e.g., via interface component 124 and/or display component 130) in response to successful login (e.g., entry of the correct username and password) by the patient John Doe in the login interface 201. The home screen interface 202 can include various selectable menu items (e.g., menu items 204-214) corresponding to different types of services and/or information provided by the PHN service provider 102 and/or PHN application 122. For example, in the embodiment shown, the home screen interface 202 includes a “friends and family” menu item 204, an “appointments” menu item, 206, a “my medical information” menu item, a “medications,” menu item, a “my wall,” menu item and a “messages menu item.” Selection of the respective menu items 204-214 from the home screen interface 202 can cause the information and/or actionable services associated with the respective menu items to open in a new interface screen, tab, window, etc.

For example, in one embodiment, selection of the “my medical information” menu item 208 can provide the patient with various types of personal patient healthcare information (described herein) received by and/or accessible to the PHN service provider 102 in accordance with various aspects and embodiments provided herein. For example, the patient's healthcare information can include information received by reception component 110 from various sources from various sources (e.g., one or more external sources/systems 134, a medical professional that provides care for the patient, a medical monitoring device employed by the patient, and the like). In some embodiments, the patient's personal healthcare information can be associated with the patient's user account (e.g., by account component 104 and/or patient information component 116). In other embodiments, the patient's personal healthcare information can include information that is accessed from one or more healthcare information sources (e.g., external sources/systems 134) on demand (e.g., via access component 112). Still in other embodiments, the personal healthcare information provided to a patient in association with selection of the “my patient information” menu item can include information that has been retrieved, collated and/or organized by patient information component 116. In various embodiments, other individuals included in the patient's PHN can be provided access one or more parts of the patient's personal health information via selection of a same or similar menu item rendered at their client devices (e.g., based on authorization to access the information provided by the patient via authorization component 108). In other embodiments, the other individuals can access one or more parts of the patient's healthcare information in association with viewing the patients profile or account.

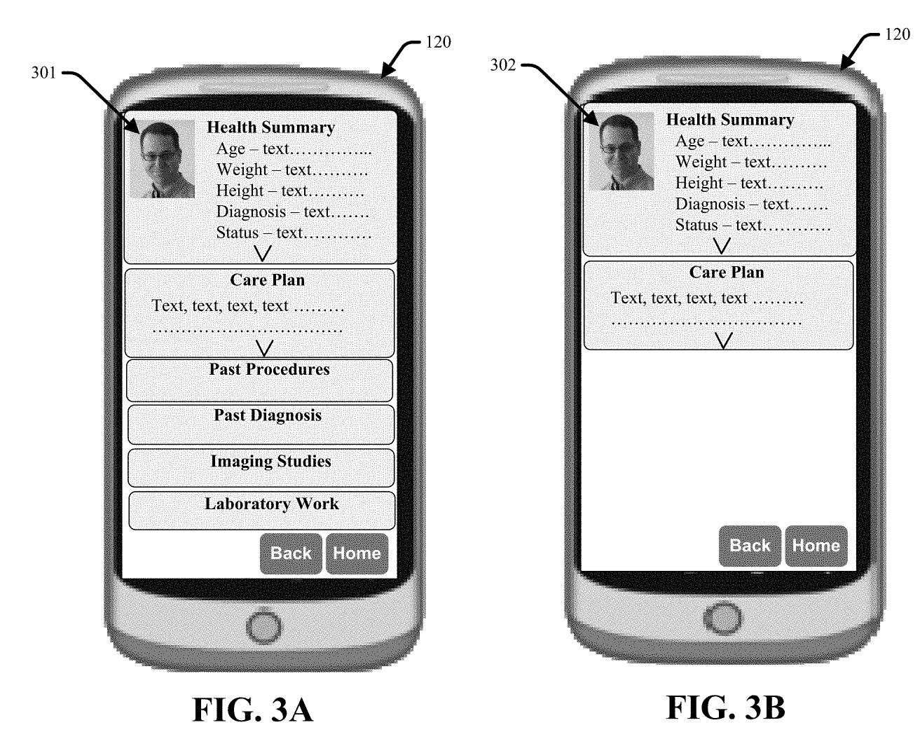

FIGS. 3A and 3B present example medical information interfaces 301 and 302 including personal healthcare information for a patient in accordance with various aspects and embodiments described herein. The medical information interfaces 301 and 302 are presented on a display (e.g., via display component 130) of a client device (e.g., client device 120) in accordance with various aspects and embodiments described herein. Repetitive description of like elements employed in respective embodiments described herein is omitted for sake of brevity.

In the embodiment shown, interfaces 301 and 302 respectively include different features and functionalities based in part on the user to whom the respective interfaces are presented. For example, as described supra, one feature afforded by the PHN service provider 102 and/or PHN application 122 can include providing a patient access to various types of personal health information for the patient collated from various sources. In association with establishing a PHN, the patient can further grant respective members of the patient's PHN access to the patient's personal health/medical information. In some embodiments, the patient and/or the security component 106 can further restrict what parts of the patient's personal medical information other members of the patient's PHN are granted access to. The patient and/or the security component 106 can also grant different members different levels of access to the patient's personal medical information. For example, the patient and/or the security component 106 can allow some close relatives access to some information considered highly sensitive while restricting other members of the patient's PHN access to such information. In another example, the patient and/or the security component 106 can authorize designated medical caregivers (e.g., the patient's doctor, nurse, etc.) access to information considered highly sensitive while restricting other members of the patient's PHN access to such information. In yet another example, the patient and/or the security component 106 can allow only some members of the patient's PHN network (e.g., authorized medical caregivers of the patient) the ability to modify (e.g., input information, comment on information, remove information, etc.) various aspects of the patient's personal medical information while inhibiting other members of the patient's PHN from editing the patient's personal medical information (e.g., including the patient).

In accordance with the aforementioned features and functionalities of system 100 (and the like), in one or more embodiments, interface 301 can be generated and presented to a first member of a patient's PHN network and interface 302 can be generated and presented to a second member of the patient's PHN network, wherein the first member has been granted access to a greater amount of personal health information associated with the patient's personal medical/health information relative to the second member. For example, in one embodiment, interface 301 can be presented to the patient himself and interface 302 can be presented to one or more members of the patient's PHN. According to this example, in one implementation, interface 301 can be generated and presented to the patient in response to selection, by the patient, of the “my medical information” menu item 208 from the home screen interface 202.

In the embodiment shown, interface 301 provides access to more personal patient medical/health information relative to interface 302. For example, interface 302 includes various categories of personal health information for the patient, including general health summary information for the patient, care plan information, past procedure information, past diagnosis information, imaging studies, and laboratory work. However, interface 302 provides access to a fewer amount of information categories relative to interface 301. For example, interface 302 only includes the health summary information category and the care plan information category. It should be appreciated that the particular type of patient healthcare information that is included in a medical information interface for a patient (e.g., medical information interface 301 and 302) can vary and that the categories presented in interfaces 301 and 302 are merely exemplary. In various implementations, the respective information categories included in interfaces 301 and 302 can be selected to review additional information respectively associated with the categories.

With reference back to FIG. 2B, each of the various additional example menu items 204, 206, 210, 212 and 214 are discussed in greater detail infra with reference with respect to FIGS. 4-15. It should be appreciated that the interfaces presented herein (e.g., interfaces 201, 202, 301 and the like) are merely exemplary and can vary. For example, the features and functionalities of the interfaces provided to a patient can include different features and functionalities relative to the interfaces that are provided to members of the patient's PHN. In another example, the features and functionalities of interfaces provided to respective members of a patient's PHN can vary depending on different roles of the respective members and different authorization or security levels associated therewith. For example, a physician of the patient may be authorized greater access to information and features provided by the PHN service provider 102 (e.g., editing patient care plan information, providing new information regarding the patients health status etc.), relative to a friend. Accordingly, the features and functionalities represented by menu items included in a user's home screen can vary depending on the types of information and/or types of services the user is authorized to access and employ.

FIG. 4 presents various components that can be included in the server community connection component 118 and/or the client community connection component 126 of system 100 in accordance with various embodiments described herein. Repetitive description of like elements employed in respective embodiments is omitted for sake of brevity.

In one or more embodiments, the server community connection component 118 and/or the client community connection component 126 can include a PHN members component 402 that facilitates accessing information regarding the individuals included in the patient's PHN. For example, in association with addition of members to a patient's PHN, the account component 104 can receive various types of user account information for the respective members. For example, such information can include but is not limited to: information identifying the respective PHN members, profile information provided by the respective members in association with establishment of their respective user accounts, contact information for the respective members, and the like. In various embodiments, the PHN members component 402 can be configured to collate and organize such information regarding respective members included in a patient's PHN and provide the patient access to such information. In some embodiments, the PHN members component 402 can also facilitate adding and removing members from a patient's PHN account. Further, in various embodiments, the PHN members component 402 can facilitate setting different authorization access controls regarding types of personal healthcare information the respective members are authorized to access and/or types of services provided by the PHN service provider 102 in association with participation in a patient's PHN that the respective members are authorized to employ.

The server community connection component 118 and/or the client community connection component 126 can also include a private messaging component 404 and a group messaging component 406 to facilitate private and group messaging, respectively, between respective members of a patient's PHN (e.g., between two or more members excluding the patient) and between the patient and respective members of the patient's PHN. For example, in various implementations, the private messaging component 404 can provide for private electronic messaging between the patient and the individuals included in the patient's PHN. Such private messaging can include sending text messages, emails, multimedia messages and the like using an existing messaging application provided on the client device 120 or a proprietary messaging application provided by the PHN service provider 102 or the PHN application 122. Similarly, the group messaging component 406 can facilitate generating and sending group messages between three or more individuals associated with a patient's PHN. For example, the group messaging component 406 can allow the patient to generate and send a group message (e.g., a text message, an email, a multimedia message and the like) to all the of the patient's PHN members or a subset of the patient's PHN group members. In another example, the group messaging component 406 can allow a member of a patient's PHN to generate and send a group message (e.g., a text message, an email, a multimedia message and the like) to the patient and all of the patient's other PHN members or a subset of individuals selected from the group consisting of the patient's PHN. Depending on the messaging application employed in the type of message sent, private and group messages can be received by respective user at their client devices 120 and/or accessed (using their respective client devices 120) via their respective user accounts.

In various additional embodiments, the server community connection component 118 and/or the client community connection component 126 can also include message board component 408 and posting component 410 to further facilitate group dissemination of healthcare information regarding the patient's healthcare to the patient and respective members included in the patients PHN. In one or more implementations, the message board component 408 can provide a suitable community or group messaging forum or platform (e.g., referred to herein as the “message board”) that can allow the patient and respective members included in the patient's PHN (as authorized by the patient), to post information associated with the patient's healthcare. The community or group message board and the respective information posted on the message board can be made accessible (e.g., as authorized by the patient) for viewing by the patient and the patient's respective PHN members. For example, using the message board component 408 and the posting component 410, a patient can post pictures, text, quotes, links, videos, etc. to the message board regarding the patient's care for respective members (as authorized by the patient) of the patient's PHN to see. Likewise, the respective members can post similar types information to the message board associated with the patient's healthcare.

In some embodiments, the group message board can function as a dynamic information information feed that is regularly updated and populated with the most recent and/or relevant posts (e.g., the most recent or relevant information can be included near the top of the message board/feed). In other embodiments, the patient or another group member authorized by the patient, can control removing posts from the message board. For example, the patient can chose what information to remove and when. In one implementation, the patient may choose to clear the information on the message board once a week, once a month, etc. Still in other embodiments, the group messaging board can be automatically configured to reset or clear the information posted thereto according to a predefined schedule (e.g., daily, weekly, monthly, etc.).

In other embodiments, in addition to and/or in the alternative to providing a group message board, the server community connection component 118 and/or the client community connection component 126 can facilitate sharing information between respective members of a patient's PHN using individual messaging boards of platforms that are respectively associated with the individuals' profiles and accessible to respective members of the group (e.g., including the patient and the one or more members). Such an individual messaging board is referred to herein as the user's wall. According to these embodiments, the server community connection component 118 and/or the client community connection component 126 can also include wall component 412 to facilitate generating, and updating information included on a individuals wall. For example, using the posting component 410 and/or the wall component 412, a patient and/or respective members of the patient's PHN can post various types of information regarding the patient's healthcare to their respective walls. In other implementations, the patient and/or respective members of the patient's PHN can also post information to each other's walls (e.g., a patient can post information to a members wall and vice versa, and/or a first member can post information to a second member's wall). In some embodiments, the wall component 412 can also allow the patient and/or members of the patient's PHN to comment on, like, share, etc., information posted on their own walls and the walls of other individuals included in the patient's PHN.

In addition to connecting and facilitating communication and collaboration between a patient and respective members of the patients PHN, in some embodiments the posting component 410 can be configured to automatically post certain defined types of information received by the reception component 110 and/or information received from defined sources to a particular messaging forum (e.g., the group messaging board, the patient's wall, the members' walls, a certain member's wall etc.). For example, in an embodiment in which the patient information component 116 regularly receives new information regarding the patient's healthcare (e.g., occurrence of patient care events, procedure results, changes to a patient's care plan, monitored physiological information indicating a change in the patient's health status, etc.), the posting information can be configured to automatically post such defined information to the group message board, the patient's wall and/or wall of the respective members.

In other embodiments, rather than posting such information to a public forum such as the group message board or a user's wall, the server community connection component 118 and/or the client community connection component 126 can include notification component 216 to generate and send personal notifications to the respective members (as authorized by the patient), and the patient. For example, in response to reception (e.g., by reception component 110) of certain defined patient healthcare information or a certain defined type of patient healthcare information (e.g., time sensitive information, defined patient care events, critical information, information classified as private, information classified as disturbing, etc.) and/or reception of information from a particular source or entity (e.g., the patient's physician, the patients, primary caregiver, the patient's, a particular healthcare service provider, etc.), the notification component 216 can be configured to generate and send private notification to the patient and/or the respective members of the patient's PHN regarding the information. In some implementations, the notification component 216 can further code the respective notifications to indicate a level of urgency associated with the notification.

In various additional embodiments, in association with providing information to a member of a patient's PHN (including the patient), via the messaging components (e.g., private messaging component 404 and group messaging component 406) as the posting component 410 and/or the notification component 216, the respective components can apply user preference information restricting what information to provide and when such that the respective members receive information according to their desired preferences. For example, in association with posting information to a public form regarding a patient's healthcare or disseminating received patient healthcare information to the patient and/or the patient's PHN members in the form of a notification (or another suitable form), the posting component 410 and/or the notification component 216 can be configured to post and/or generate and send notification based on preferences of the patient, preferences and/or traits of the members, and/or a current context of the patient and/or the respective members. For example, as described above, using authorization component 108, a patient can restrict what type of information associated with the patient's healthcare is disclosed to respective members of the patient's PHN network. For instance, the patient can authorize a first user to receive information classified as mildly sensitive only while authorizing a second member to receive all types of information, regardless of classification. Accordingly, in one or more embodiments, the posting component 410 and the notification component 216 can be configured to post information appropriately according the authorization schemes implemented by the patient.

In other implementations, respective members of the patient's PHN (including the patient) can apply their own preferences regarding the type and/or source of information they would like to receive (or not receive) from the respective messaging components, the posting component 410 and the notification component 216. The respective messaging components, the posting component 410 and the notification component 216 can further be configured to disclose patient healthcare information based on the preferences provided by the respective members. Such user preference information can be provided by the user in association with establishing an account with the PHN service provider and the user preference information can be associated with the user's account. For example, a first member of the patient's PHN may elect to only receive notification with positive information regarding the patient's healthcare. In another example, a second member of the patient's PHN may elect to only receive notifications regarding the patient's healthcare related to information received from a specific healthcare service provider.

According to these implementations, in addition to providing preferences regarding information type and source, respective members of the patient's PHN (including the patient), can also provide preferences regarding when they would like to receive certain information from the posting component 410 and/or the notification component 216. For example, a user can define context information regarding facts associated with certain contexts under which the user would like or would not like to receive certain types of information and/or information from certain sources. Such context information can include for example but not limited to: time of day, day of week, user location, user activity (e.g., driving, working, attending school, etc.), user mental state, whether the user is alone or with company, and the like. For instance a patient's mother may indicate that she does not want to receive critical patient updates while she is driving. In another example, the patient's son may indicate he does not want to receive information (e.g., via posting component 410 and/or notification component 216) regarding the outcome of the patient's latest surgical procedure when he is alone or when he is not located with the patient.

The server community connection component 118 and/or the client community connection component 126 can further include context component 218 to facilitate determining a current user context prior to providing a user with information (e.g., via the respective messaging components, the posting component 410 and/or notification component 216), such that the user receives the information (or does not receive the information) based on the contextual preferences applied by the user. For example, the context component 218 can be configured to determine or receive information regarding a current location of a user (or the user's client device 120) using various existing location determination methods. The context component 218 can also employ a clock and/or calendar to determine time of day, day of week information. The context component 218 can further have access to user schedule information regarding a defined schedule of the user to determine a current activity of the user (e.g., at work, in a meeting, in class, at soccer practice, etc.). In another implementation, the context component 218 can determine a user's current mobility state based on motion information detected by the users' client device and/or real-time location tracking. The context component 218 can also employ various techniques to determine when a user is located within proximity to other users (e.g., via respective locations of the client devices 120) and the identities of the other users with whom the user is located near (e.g., via information accessible to the context component 218 that associates device identifiers for their respective client device 120 with user identifiers).

In an additional embodiment, the server community connection component 118 and/or the client community connection component 126 can further include healthcare support component 418 to facilitate connecting patients and their respective PHN members to knowledgeable medical care professionals to ask questions and receive advice or information associated with the patients' healthcare. These medical care professionals can include individuals and/or entities that are involved in the patient's care (e.g., the patient's physician, the patient's nurse, an administrator at the patient's assisted living facility, etc.) as well as individuals and entities that may not be involved in the patient's care yet have professional expertise and knowledge in various healthcare areas relevant to the patient's care. For example, in some embodiments, the healthcare support component 418 can provide a user having an account with the PHN service provider (e.g., a patient and/or the patient's PHN members), access to a directory of medical care professionals that the user can pose questions to and receive answers and advice from. In an aspect, the healthcare support component 418 can allow the user to connect with such healthcare professionals using a private message (e.g., via private messaging component 404), using a group message (e.g., via group messaging component 406) and/or by posting the question to a public or community message board, such as the group message board, the user wall, or another user's wall (e.g., including the patient and other members of the patient's PHN). In embodiments in which questions and/or requests for information and advice from one or more healthcare professionals is posted to such a public or community message forum, the responses to the questions and the requests can likewise be posted (e.g., via the posting component 410) to the public or message forum. Accordingly, the other members of the patient's PHN will also be able to see and benefit from information provided by the healthcare professionals regarding the patient's care. Thus the healthcare support component 418 provides not only the patient but also others in the patient's PHN who are involved in the patient's care to ask designated medical professionals questions regarding the patient, with respective members of the patients PHN (e.g., as authorized by the patient) being able to see and comment on the response.

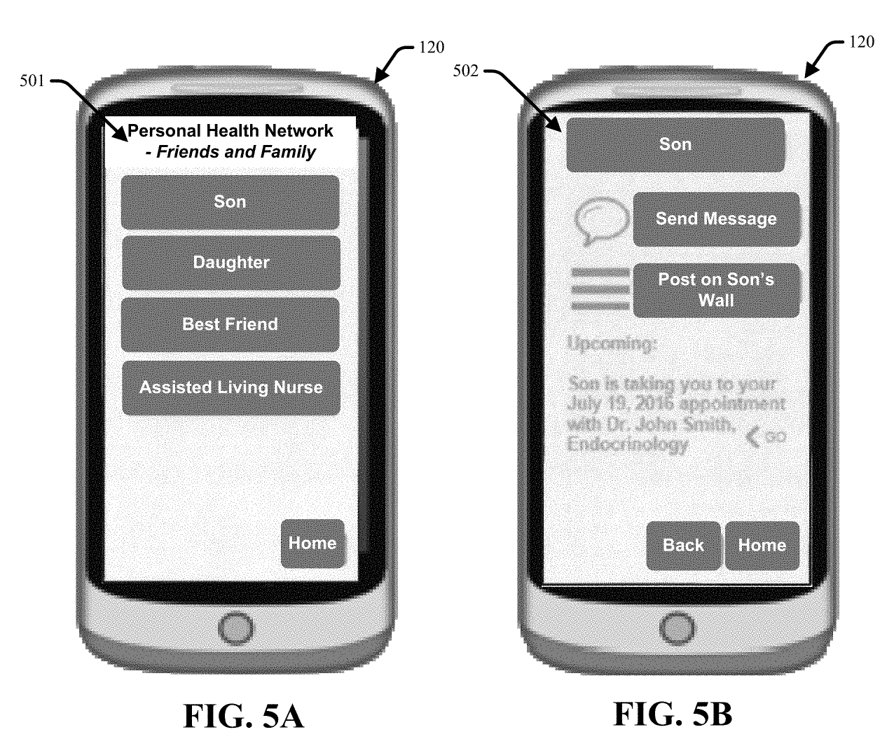

FIGS. 5A, 5B, 6, 7 and 8 present various example interfaces (e.g. interfaces 501, 502, 601, 701 and 801) that demonstrate one or more features and functionalities of the server community connection component 118 and/or the client community connection component 126 in accordance with various aspects and embodiments described herein. In one or more embodiments, the respective interfaces 501-801 can be generated at a client device 120 using the interface component 124 in association with employment of the PHN application 122 provided on the client device 120. In other embodiments, the respective interfaces can be generated using a browser provided on the client device 120 in association with access of a website provided by the PHN service provider 102. Repetitive description of like elements employed in respective embodiments described herein is omitted for sake of brevity.

With reference initially to FIG. 5A, in an aspect, interface 501 can be generated in response to selection of the “friends and family” menu item 204 from the home screen interface 202 depicted in FIG. 2B. As previously noted, the home screen interface 202 includes a home screen interface for a patient (John Doe) that has an established PHN via affirmatively selecting and authorizing certain people to be included in his PHN. In one or more implementations, selection of the friends and family menu item 204 facilitates accessing information regarding the individuals included in the patient's PHN in accordance with various aspects and embodiments described herein (e.g., via PHN members component 402). For example, in the embodiment shown, interface 501 includes a list of selectable icons respectively corresponding to the respective member's included in the patient's PHN. With regard to fictional patient John Doe, the members included in John Doe's PHN include his son, his daughter, his best friend, and his assisted living nurse. In various embodiments, the patient can select the respective icons to access various types of information regarding the respective members. In one embodiment, selection of an icon corresponding to one of the patient's PHN members from interface 501 can bring the patient to a another interface that facilitates communicating with the member (e.g., using private messaging component 404, group messaging component 406, message board component 408, posting component 410 and/or wall component 412).

For example, FIG. 5B provides one potential example interface 502 that can be generated in response to selection of an icon from interface 501 corresponding to the patient's son. Interface 502 includes a first interactive icon entitled “send message” via which the patient can select to initiate sending a private or group message to the patient's son (e.g., using an existing messaging client provided on the client device 120 or a proprietary messaging client associated with the PHN application 122. Interface 502 also includes a second icon entitled “post on Son's wall” via which the patient can select to initiate posting a message on his Son's wall. In some implementations, messages posted on the Son's wall can be accessible to the Son, the patient, and/or other members of the patient's PHN.

In addition, in some embodiments, in association with selection of the icon corresponding to a particular member of the patient's PHN from interface 501, the PHN application 122 can include additional information in the next interface (e.g., interface 502) associated with the member regarding the member's recent and/or upcoming involvement in the patient's healthcare as facilitated via the PHN. For example, in the embodiment shown, interface 502 includes additional information regarding an upcoming interaction between the patient and the patient's Son that is related to the patient's healthcare. For instance, the next interaction in this example involves the patient's Son taking the patient to his appointment with Dr. John Smith on July 19. In various embodiments, as described infra, the PHN service provider 102 and/or the PHN application 122 can facilitate scheduling and managing patient appointments, including scheduling attendance/involvement of the patient's PHN members with the patient's appointments.

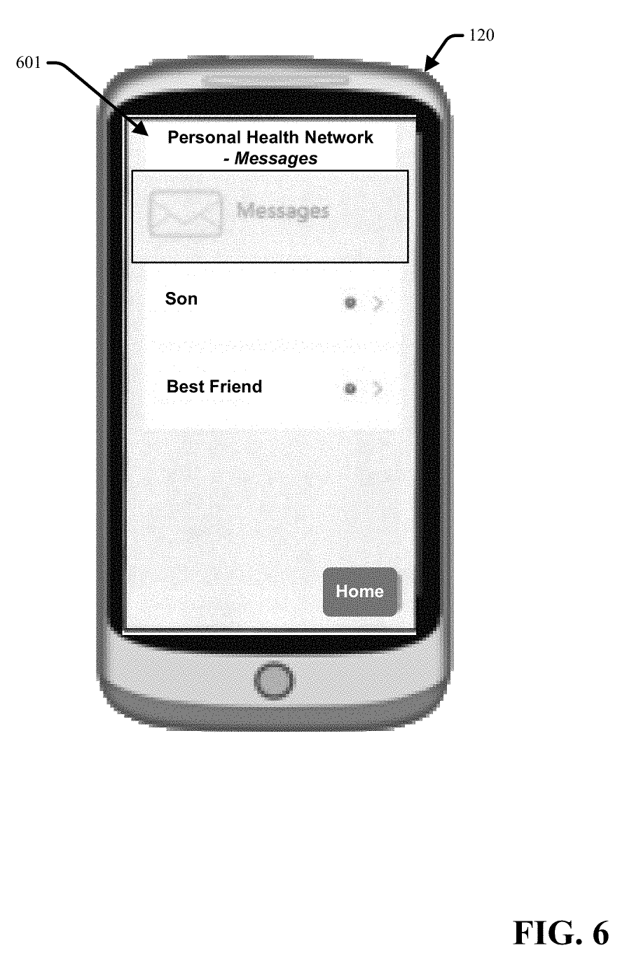

FIG. 6 presents an example interface 601 that can facilitate sending and receiving private and/or group messages between the patient and one or more members included in the patient's PHN. In an aspect, interface 601 can be generated in response to selection of the “messages” menu item 214 from the home screen interface 202 depicted in FIG. 2. For example, in the embodiment shown, the messaging interface 601 depicts a message private text message or email chain existing between the patient and the patient's Son and the patient and the patient's best friend. In an aspect, selection of either of these messaging icons can render the text or email dialogue previous conducted between the patient and the patient's son, and the patient and the patient's best friend, respectively.

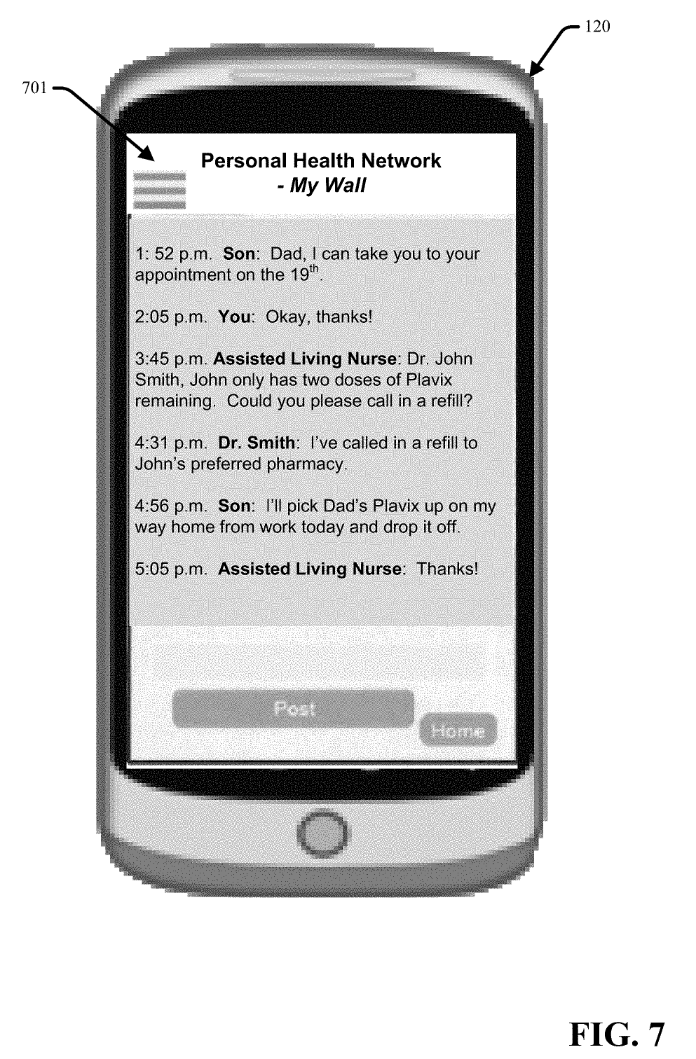

FIG. 7 presents an example interface 701 including a wall generated for a patient in association with the patient's PHN in accordance with various embodiments provided herein. In an aspect, interface 701 can be generated in response to selection of the “my wall” menu item 212 from the home screen interface 202. As shown in interface 701, the wall includes information posted by various people included in the patient's PHN, including the patient's Son, the patient's assisted living nurse, and Dr. Smith (who may have been recently added to the John Doe's PHN network or otherwise provided access to the patient's PHN network). By posting sharing information via the patient's wall, the patient can be informed about activity regarding his healthcare involving all possible members of the patient's PHN. Further, the patient's wall allows the members of the patient's PHN to efficiently coordinate roles and responsibilities associated with the patient's healthcare needs (e.g., taking the patient to his appointment, calling in the patient's prescription information, picking up the patient prescription information, etc.). Further because the patient and all members of the patient's PHN are provided access to the patient's wall, the patient's wall facilitates efficient and effective group dissemination of patient healthcare information to the appropriate entities.

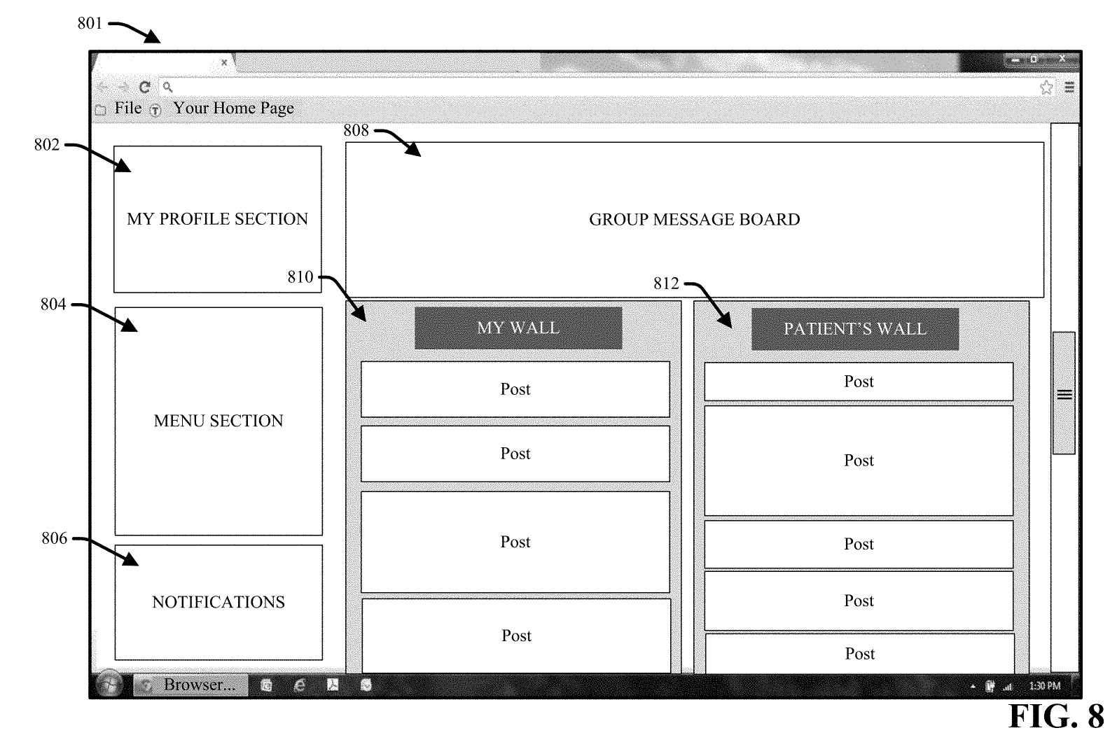

FIG. 8 presents an example interface 801 of a homepage for a member of a patient's PHN in accordance with various aspects and embodiments described herein. In various embodiments, one or more features and functionalities of interface 801 can also be included in an example homage interface for a patient account. In the embodiment shown, interface 801 can be generated in association with access of a website version of the PHN service provider 102. Interface 801 can include various sections that include information and/or provide access to additional information and/or services provided by the PHN service provider.

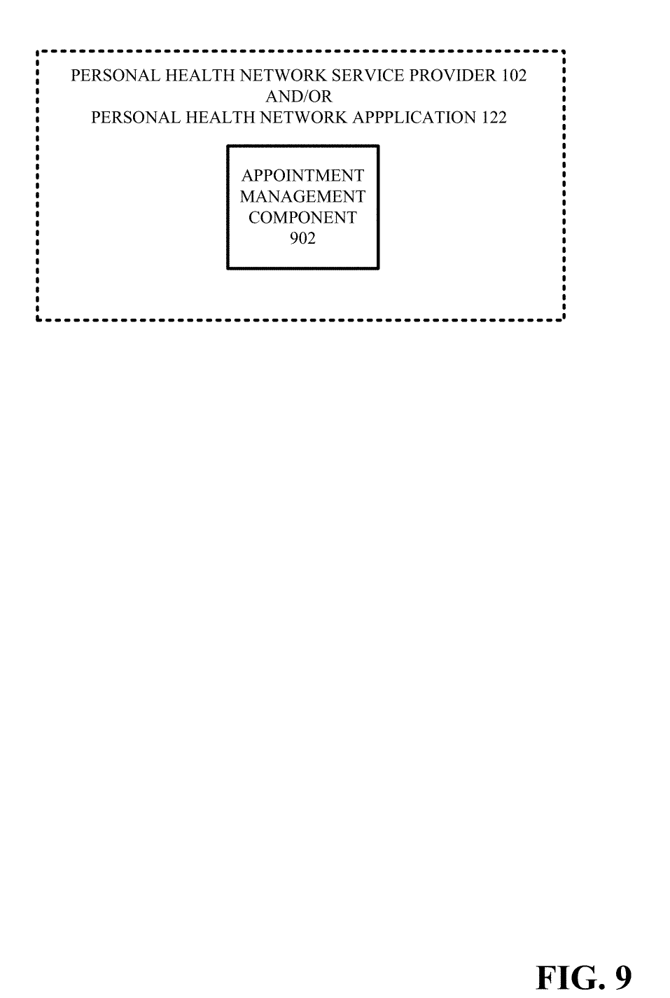

For example, the “my profile section” 802 can include a summary of the user's profile, a profile picture, a link to access the members profile information, and the like. The menu section 804 can includes menu items that the same or similar to menu items provided in the home screen interface 202 of FIG. 2. For example, the menu section 804 can include “a family and friends menu item” that provides the member access to information regarding the patient and other member included in the patient's PHN. The menu section 804 can also include quick links to relevant patient information (e.g., patient health information, patient medication information, patient care plan information, educational information regarding the patient's illness/condition, etc.). The menu section 804 can also include menu items for interactive services provided by the PHN that the patient is giving access to (e.g., via the patients authorization). For example, such interactive services can include an appointments service that facilitates managing and scheduling attendance to patient appointments. The interactive services can further include messaging services, healthcare support services (e.g., provided by healthcare support component 418), an appointment scheduling services, medication management services, patient health status monitoring services, donation and gift giving services, and the like. Many of the services are described in greater detail infra with respect to FIGS. 9-15.

In addition, interface 801 can include a notifications section that includes one or more notifications regarding the patient's healthcare as generated by notification component 414. For example, the notifications can include notifications regarding information received by the PHN service provider 102 (e.g., via reception component 110) that the notification component 414 has been configured to provide notifications for (e.g., pertinent patient care events, laboratory results, imaging study results, diagnosis information, time sensitive information, information from a particular source, information classified as urgent, etc.). In one or more embodiments, the notifications that are included in the notifications section 806 can be based on authorization information provided by the patient (regarding what information the particular member is authorized to have access to), profile/preference information of the member, and a current context of the member.

Interface 801 further includes a group message board 808 via which all (patient authorized) members (and the patient) can post information associated with the patient's healthcare. For example such information can include text, images, media, multimedia and the like. In an aspect, the group message board can be place where members post uplifting and encouraging information, such as personal positive messages, quotes, images, video, animation, etc., intended to make the patient smile, raise the patient's spirits, and/or simply provide the patient a continuous and dynamic reminder of the all the love and support the patient has from his or her PHN. The member home interface can also include a personal wall 810 for the member via the member and other member can post and share particular information associated with the patient's healthcare that is relevant to the member. In the embodiment shown, interface 801 can also include the patient's wall 812 (if authorized by the patient). Like the member's personal wall 810 the patient's wall 812 can include information posted by the patient that the patient wants to broadcast to all members of the patient's PHN as well as information posted and/or other members that is particularly relevant to the patient (e.g., intended for the patient to see). In other embodiments, the member can access the patient's wall via the patient's profile page (if authorized by the patient).

FIG. 9 presents integration of an example appointment management component 902 into a PHN service provider 102 and/or a PHN application 122 associated with an example PHN system (e.g., PHN system 100) in accordance with various embodiments described herein. With reference to FIGS. 1 and 9, in one embodiment of system 100, the appointment management component 902 can be provided at the PHN service provider 102 or the PHN application 122 of the client device 120. In another embodiment of system 100, various operations of the appointment management component 902 can be distributed between the PHN service provider 102 and the PHN application 122 of the client device 120. Accordingly, the appointment management component 902 is shown in a dashed box identified as PHN service provider 102 and/or PHN application 122 to indicate theses different embodiments. Repetitive description of like elements employed in respective embodiments is omitted for sake of brevity.

In one or more embodiments, the appointment management component 902 can be configured to facilitate managing involvement of respective members of a patient's PHN in healthcare related appointments scheduled for the patient. For example, in various embodiments, the PHN service provider 102 can receive (e.g., via reception component 110) information regarding healthcare appointments scheduled for the patient, such as physician appointments, therapy appointments, testing appointments, consultation appointments, etc. In one or more implementations, the appointment information can include at a least a time and date of the appointment and a location of the appointment. The appointment information can further include additional detailed information associated with the appointment, such as but not limited to: information regarding who the patient will be visiting, the purpose of the appointment, what to expect at the appointment, how to prepare for the appointment, and the like. In some implementations, the reception component 110 and/or the patient information component 116 can be configured to receive patient appointment information from a patient scheduling system employed by the health care service provider with whom the patient's appointed is with. According to these embodiments, the reception component 110 and/or the patient information component 116 can be configured to automatically receive patient appointment information from the health care provider's scheduling system in response to scheduling of an appointment. In other embodiments, the reception component 110 can receive patient appointment information from various other sources (e.g., other external systems/sources scanned by the patient information component 116, the patient directly, a caregiver for the patient, a member of the patient's PHN, etc.).

Based on received appointment information, in one or more embodiments, the appointment management component 902 can update a scheduling calendar associated with the PHN service provider 102 and/or the PHN application 122 that tracks various types of information for the patient by date and time, including at least appointments scheduled for the patient. In some embodiments, the appointment management component 902 can further notify the patient and the respective members of the patient's PHN regarding the patient's upcoming appointments, including any information known about the appointment (e.g., time, place, duration, purpose, requirements, what to expect, etc.).

The appointment management component 902 can further facilitate registering one or members of the patient's PHN to attend an appointment with the patient (e.g., in person). For example, the appointment management component 902 can provide an interactive service that allows authorized members of the patient's PHN to access appointment information for the patient (e.g., gathered and retained at the PHN service provider 102) identifying upcoming scheduled appointments and any additional information associated with the upcoming appointments (e.g., time, place, duration, purpose, requirements, what to expect etc.). The appointment management component 902 can further allow members of the patient's PHN to register to provide various types of assistance to the patient in association with the patient's scheduled appointments. For example, the appointment management component 902 can allow respective members of the patient's PHN to input information claiming or reserving one or more responsibilities to perform associated with a patient's upcoming appointment, including but not limited to: driving the patient to the appointment, staying with the patient during the appointment, driving the patient home from the appointment, attending to the patient after the appointment, and the like. It should be appreciated that the responsibilities can vary depending on the patient and the type of the appointment.

In some implementations, the patient can provide information identifying and/or requesting certain responsibilities or types of assistance desired for performance by one or more of the patient's PHN members in association with the patient's scheduled appointments. Further in other embodiments, the appointment management component 902 can allow the patient to request certain members for certain responsibilities and certain appointments. For instance, John Doe may request his daughter to accompany him to his upcoming check-up appointment because she will be in town visiting and he would love to spend some extra time with her. The appointment management component 902 can further manage such special requests to facilitate serving them when possible. For example, in association with reception of a special request directed to John Doe's daughter regarding his upcoming check-up appointment, the appointment management component 902 can be configured to interpret the request and send a personal message to John Doe's daughter regarding the special request prior to allowing other members of the patient's PHN to sign up to attend the patient's appointment.

The appointment management component 902 can also be configured to notify the patient in response to reception of a claim or reservation of an appointment responsibility by member of the patient's PHN. For example, the notification can appear in a private message sent to the patient, on the patient's wall for other members to see, on the group message board, and the like. The appointment management component 902 can also notify the patient and the respective group members if a patient has an upcoming appointment for which the one or more appointment responsibilities have not been reserved or claimed (e.g., appointments for which the patient needs assistance attending and none of the respective group members have signed up to provide the assistance). Accordingly, the respective group members can coordinate amongst themselves (e.g., using the various communication and connection services provided by the PHN service provider 102) who can take the patient to his or her appointment before the appointment date and time. In some embodiments in which the appointment responsibilities cannot be fulfilled by any of the patient's PHN group members, the appointment management component 902 can facilitate rescheduling the patient's appointment. In addition, the appointment management component 902 can allow members of the patient's PHN to unclaim or release an appointment responsibility he or she previously registered for in the event the member can no longer fulfill the duty. In response to reception of user input unclaiming or releasing an appointment duty, the appointment management component 902 can further notify the patient and the other members of the patient's PHN regarding the appointment responsibility becoming open or unclaimed so that another member can claim it.

In some embodiments, the appointment management component 902 can further facilitate registering one or more members of a patient's PHN to attend an appointment of the patient via a videoconference. For example, in association with providing PHN group members access to the patient's appointment information and facilitating registering to physically attend or otherwise participate in the patient's appointments, the appointment management component 902 can also allow one or more members (as authorized by the patient) to request to participate in a live videoconference of the appointment using a suitable videoconferencing service. The patient can further authorize the one or more members of the patient's PHN to participate in the live videoconference prior to allowing them to receive the live videoconference. In one example embodiment, when the patient receives a request for a videoconference during an appointment, the patient can set up (or have another person help set up) a live videoconference during the patient's appointment using various proprietary or non-proprietary real-time video conferencing technology provided on the patient's client device (or another suitable device that can be used during the patient's appointment). During the webcast the other members can simply observe the appointment or actively participate in the appointment (e.g., by talking to the patient, the patient's medical health professional, etc.). With this videoconferencing feature, any person in the patient's PHN may schedule attendance via videoconference, such that an out-of-state relative or a friend that is unable to drive or otherwise physically attend the appointment is still able to participate in the appointment.

In an embodiment, the videoconference can be performed using a camera on the patient's client device and a video conferencing service associated with the PHN service provider 102, the PHN application 122, and/or the client device 120. According to this embodiment, the appointment management component 902 can also facilitate controlling performance of the videoconference. For example, in one implementation the appointment management component 902 can facilitate establishing the videoconference using videoconferencing ability and associated applications that are ubiquitous in many commercially available client devices (e.g., smartphones, tablets, PCs, Internet enabled televisions, and the like) to create the webcasting experience. According to this implementation, the appointment management component 902 can employ the videoconferencing application (e.g., using the appropriate application programming interface (API)) to perform the videoconference). In another implementation, the videoconferencing application can include a proprietary application associated with the PHN application and/or PHN service provider 102.

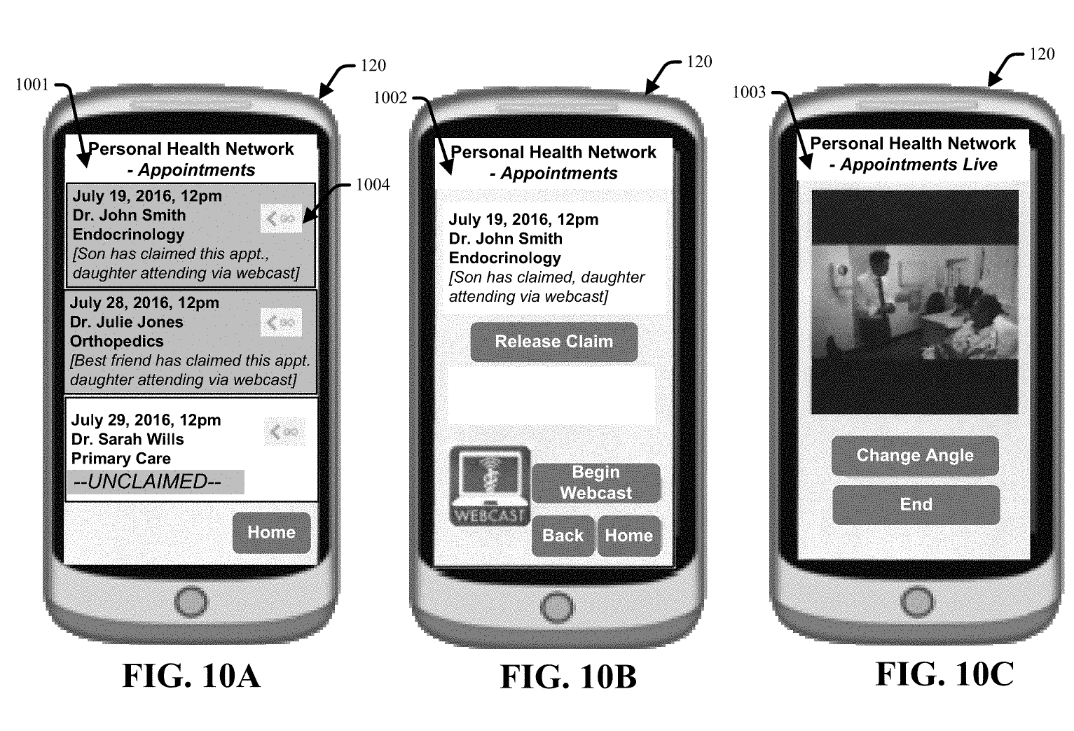

FIGS. 10A-C present example interfaces (interfaces 1001, 1002, and 1003) facilitated by the appointment management component 902 of the example PHN system 100 in accordance with various embodiments described herein. In the embodiment shown, interfaces 1001, 1002 and 1003 are presented to the patient, which in this case is John Doe, in association with usage of the PHN application 122 and/or the PHN service provider 102 via his client device 120. Repetitive description of like elements employed in respective embodiments is omitted for sake of brevity.

With reference to FIG. 10A, in one embodiment, interface 1001 can be generated (e.g., by interface component 124), in response to selection of the “appointment” menu item 206 from the home screen interface 202 presented in FIG. 2B. Interface 1001 includes a list of upcoming appointments for the patient. Each of the appointments includes information describing the date and time of the appointment, the physician associated with the appointment, and the medical area associated with the appointment. The first two appointments also include information indicating claimed involvement of respective PHN group members in the appointment. For example, with respect to the first appointment scheduled for Jul. 19, 2016, the patient's son has claimed the appointment (which can mean that the patient's son will be taking the patient to the appointment and attending the appointment in person) and the patient's daughter has registered to attend via webcast. Similarly, with respect to the second appointment scheduled for Jul. 28, 2016, the patient's best friend has claimed the appointment and the patient's daughter has registered to attend via webcast. The third appointment scheduled for Jul. 29, 2016 however has not been claimed yet. Each of the appointments also includes a selection icon 1004 that can be selected to view additional information associated with the appointment and in some embodiments, access additional application functions associated with the appointment.

For example, FIG. 10B presents an example interface 1002 generated in response to selection of the selection icon 1004 by the patient from interface 1002. Via interface 1002, the patient can release his Son's claim to attend the appointment via selection of the “release claim” soft button. In an aspect, in response to selection of the “release claim” button, the Son can receive a notification (e.g., generated and sent by the appointment management component 902) at his client device (e.g., via his user account with the PHN service provider) indicating the patient has released his claim to the appointment and he is no longer requested to attend the appointment. Interface 1002 also includes an option to begin the webcast. In an aspect, selection of the “begin webcast” icon activates a videoconferencing application provided on the client device 120 and initiates the videoconference (e.g., using a camera provided on the client device 120 or another device).

For example, FIG. 10C presents an example interface 1003 generated in response to selection of the “begin webcast” icon by the patient from interface 1002. As shown in interface 1002, a live video of the appointment is displayed with an option to change the angle of the camera or end the webcast. In this example, another person may be holding the patient's client device 120 to capture the video (or the client device 120 may be placed on tripod or other suitable mount), or another device communicatively coupled to the client device 120 located in the appointment room may be capturing the video imagery. In an aspect, the patient's daughter can be presented with an interface that is the same or substantially similar to interface 1003 on her client device (e.g., in association with access of her user account with the PHN service provider 102).

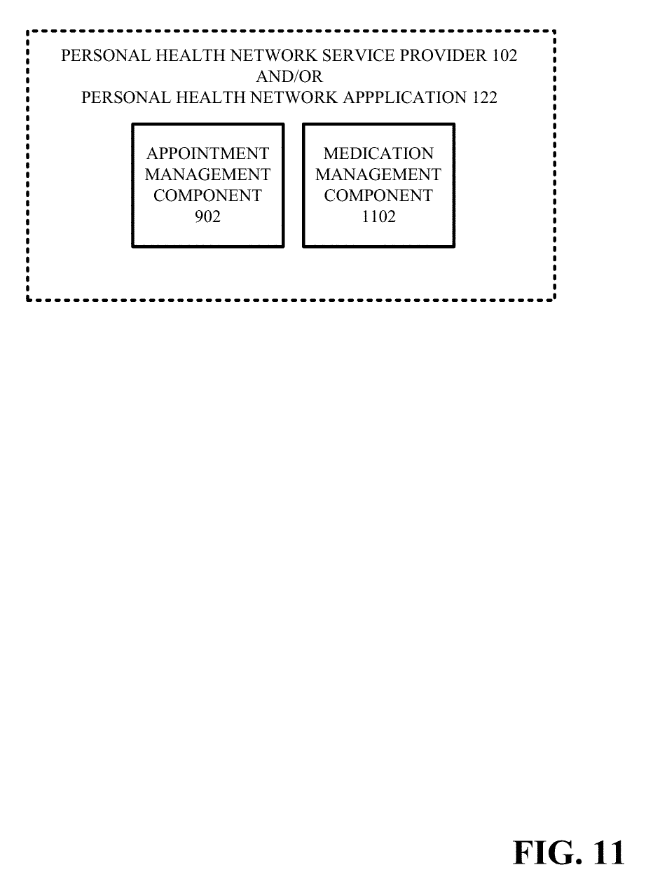

FIG. 11 presents integration of an example medication management component 1102 into a PHN network service provider and/or a PHN application associated with an example PHN system in accordance with various embodiments described herein. With reference to FIGS. 1 and 11, in one embodiment of system 100, the medication management component 1102 can be provided at the PHN service provider 102 or the PHN application 122 of the client device 120. In another embodiment of system 100, various operations of the medication management component 1102 can be distributed between the PHN service provider 102 and the PHN application 122 of the client device 120. Accordingly, the medication management component 1102 is shown in a dashed box identified as PHN service provider 102 and/or PHN application 122 to indicate theses different embodiments. Repetitive description of like elements employed in respective embodiments is omitted for sake of brevity.

In one or more embodiments, the medication management component 1102 can be configured to facilitate managing a patient's medication regimen. In an aspect, the medication management component 1102 can access information regarding a patient's medication regimen, including but not limited to: information identifying what medications the patient is instructed to take and when, the dosage of the medications, when the medications are filled, and when the medications need to be refilled. For example, in some embodiments, such medication regimen information can be located at the PHN service provider 102 (e.g., in memory 114) and/or or retrieved by the patient information component 116 and from one or more external sources/systems 134.

In addition to providing the patient and the patient's PHN members (as authorized by the patient) access to the patient's medication regimen information (e.g., via access component 112), the medication management component 1102 can also provide various interactive services that facilitate monitoring the patient's medication regimen and guiding the patient in association with adhering to the medication regimen. For example, in one embodiment, in accordance with the patient's medication regimen, the medication management component 1102 can notify the patient regarding what medications the patient is instructed to take and when. For example, the each time the patient is intended to take a medication the medication management component 1102 can notify the patient via the patient's user account with the PHN service provider 102 or via a notification sent directly to the patient's client device 120. For example, each time the patient is instructed to take a particular medication, the medication management component 1102 can send a notification regarding the instruction to the patient in a private message, post the notification to the patient's wall, post the notification to a designated notification tab or section of the patient's profile, etc. In another example, the medication management component 1102 can provide the patient with a daily list of the medications the patient is instructed to take and when.

The medication management component 1102 can further be configured to receive responses from the patient indicating that the patient has take the medication according to his regimen (e.g., at the time directed). For example, in association with receiving a notification regarding a medication the patient is instructed to take, the patient can be presented with an interactive prompt that allows the patient to send a response indicating whether the patient took the medication as directed. Via the prompt, the patient can send a response to the medication management component 1102 indicating that the patient did take the medication as directed. According to this embodiment, if the medication management component 1102 does not receive a response to a notification message affirming the patient has taken the medication at the directed time, the medication management component 1102 can perform one or more function to further prompt the patient to take the medication. For example, in one implementation, in response to failure to receive a response from the patient indicating the patient has taken his medication as initially prompted, the medication management component 1102 can send the patient a second more urgent notification information the patient he missed his medication (e.g., in the form of a text message, a call, etc.). In another example, the medication management component 1102 can generate an alert or notification that is presented to the patient via the patient's account with the PHN service provider 102, such as on the patient's homepage, profile, wall, or the like. The alert can remain until the patient responds and affirms he has taken the directed medication. In another example, the medication management component 1102 can notify other members of the patient's PHN regarding the patient's failure to indicate he has taken his medication as directed. For instance, the medication management component 1102 can send a private notification to one or more of the members (as authorized by the patient), post a notification to the patient's wall that is visible to the other members, post a notification to the respective members' walls, post a notification to the group message board, and the like.

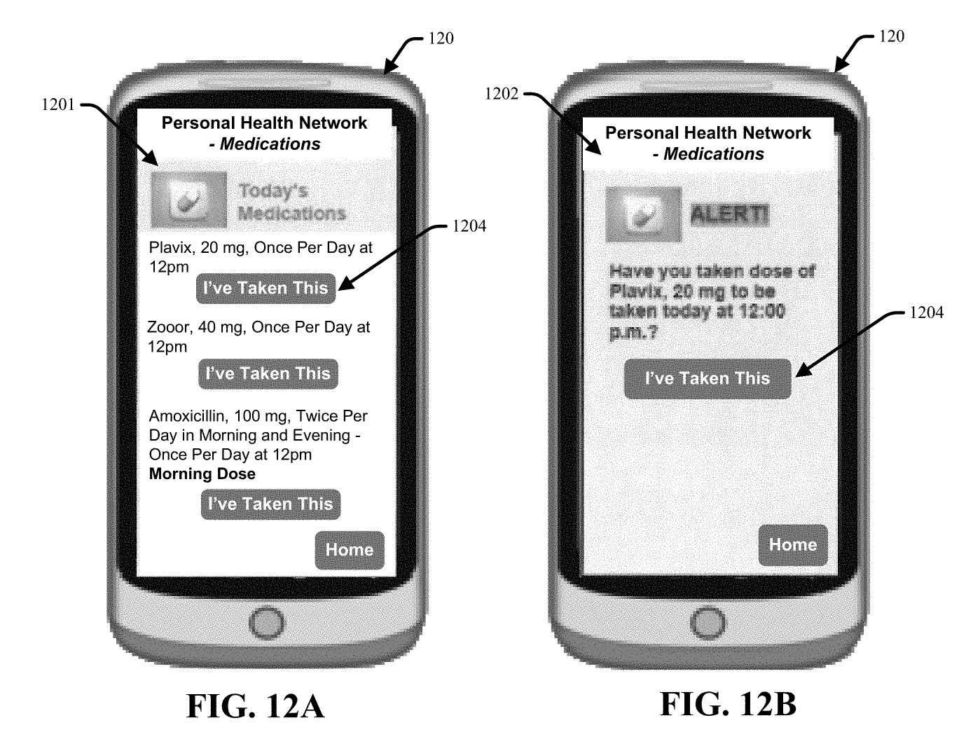

FIGS. 12 A-B present example interfaces (interfaces 1201 and 1202) facilitated by the medication management component 1102 of the example PHN system 100 in accordance with various embodiments described herein. In the embodiment shown, interfaces 1201 and 1202 are presented to the patient, which in this case is John Doe, in association with usage of the PHN application 122 and/or the PHN service provider 102 via his client device 120. Repetitive description of like elements employed in respective embodiments is omitted for sake of brevity.

With reference to FIG. 12A, in one embodiment, interface 1201 can be generated (e.g., by interface component 124), in response to selection of the “medications” menu item 210 from the home screen interface 202 presented in FIG. 2B. Interface 1201 includes a list of medications the patient is instructed to take for the day and the times at which the patient is instructed to take them. In an aspect, this list can be generated daily (e.g., by the medication management component 1102) and accessed via the “medications” menu item 210 of the patient's user account with the PHN service provider 102. Interactive icons 1204 are further associated with each medication on the list that allow the patient to select the icon to indicate when the patient has taken the medication as directed. In an aspect, in response to selection of an icon indicating the patient has taken the medication as directed, the medication can be removed from the list or otherwise marked as taken. In some embodiments, other members of the patient's PHN can also be notified that the patient has taken his medication as directed. In one embodiment, in response to failure to timely select an interactive icon 1204 indicating the patient has taken a particular medication at the directed time, the medication management component 1102 can alert the patient (and/or the one or more of the patient's PHN group members).

For example, FIG. 12B presents an example interface 1202 generated and presented to the patient in response to failure to indicate that he has take his Plavix medication on time. In an aspect, interface 1202 can be presented to the patient after a passage of a defined period of time (e.g., 10 minutes) in which a response is not received from the patient indicating the patient took his Plavix medication at 12 pm. In another aspect, the patient can receive an alert message or icon at his client device 120 (e.g., presented to the user in association with his patient account with the PHN service provider 102) and selection of the alert message or icon can result in presentation of interface 1202 to the patient. Interface 1202 also includes an interactive icon 1204 that allows the user to select to indicate he has taken his medication to remove the alert.

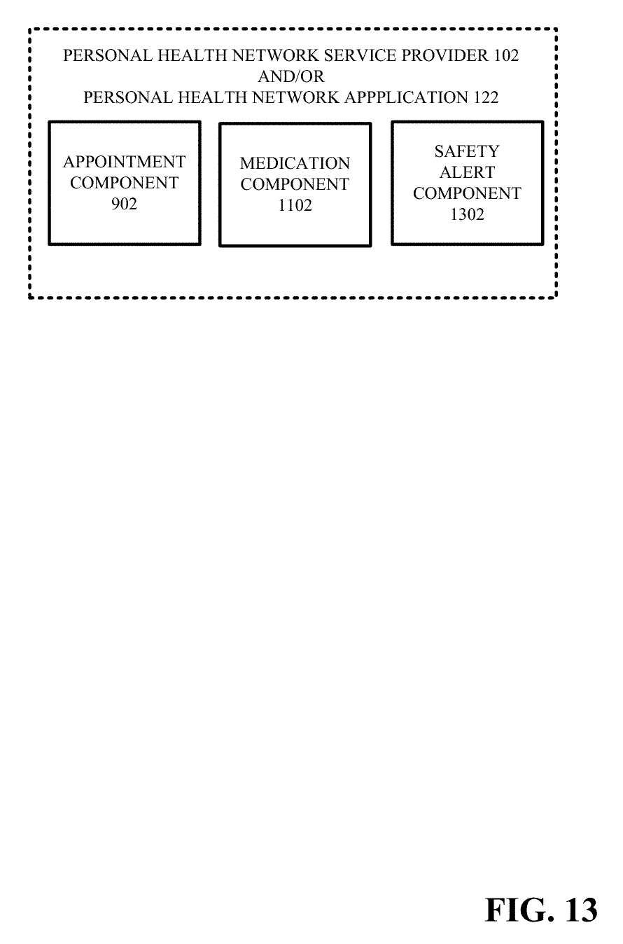

FIG. 13 presents integration of an example safety alert component 1302 into a PHN service provider 102 and/or a PHN application associated with an example PHN system in accordance with various embodiments described herein. With reference to FIGS. 1 and 13, in one embodiment of system 100, the safety alert component 1302 can be provided at the PHN service provider 102 or the PHN application 122 of the client device 120. In another embodiment of system 100, various operations of the safety alert component 1302 can be distributed between the PHN service provider 102 and the PHN application 122 of the client device 120. Accordingly, the safety alert component 1302 is shown in a dashed box identified as PHN service provider 102 and/or PHN application 122 to indicate theses different embodiments. Repetitive description of like elements employed in respective embodiments is omitted for sake of brevity.

In one or more embodiments, the safety alert component 1302 can be configured to automatically alert the patient and the patient's PHN members (as authorized by the patient) regarding information received by the PHN service provider 102 (e.g., via reception component 110) identifying safety concerns associated with the patient's care. For example, such safety concern information can be generated and provided by one or more external sources/systems 134 associated with healthcare services provider's, as well as from members of the patient's PHN (e.g., sent to the PHN service provider 102 using their respective client devices 120). Such safety concern information can relate to the patient's physical or mental health. For example a patient may be determined to be at risk of falling during a physician appointment or stay in the hospital. If this happens, the patient's caregiver at the physician appointment or hospital can provide information directly to the PHN service provider 102 or to another system associated with the physician or hospital that is accessible to the PHN service provider 102 (e.g., the one or more external sources/systems). For example, the caregiver can provide information indicating the patient is at risk for falling.

Based on reception of information identifying a safety risk, the safety alert component 1302 can generate and provide a notification message to the patient and the patient's PHN members. For example, in one embodiment, the safety alert component 1302 can send the patient and/or the patient's PHN members private messages regarding the safety concern. The private messages can be sent to their respective user accounts and/or directly to their client devices 120 (e.g., as text message, a notification, voicemail, etc.). In another example embodiment, the safety alert component 1302 can generate a notification regarding the safety concern and post the notification to respective walls of the patient and the patient's members or the group message board such that everyone in the patient's PHN can see the safety notification and what they can do to help the patient remain safe. For instance, with respect to the fall risk example, a safety alert indicating the patient is at risk for falling that is posted on the patient's wall can lead to suggestions provided by the respective members of the patient's PHN on the patient's wall regarding mechanism for the patient to reduce the chance of falling (e.g., securing loose carpet).

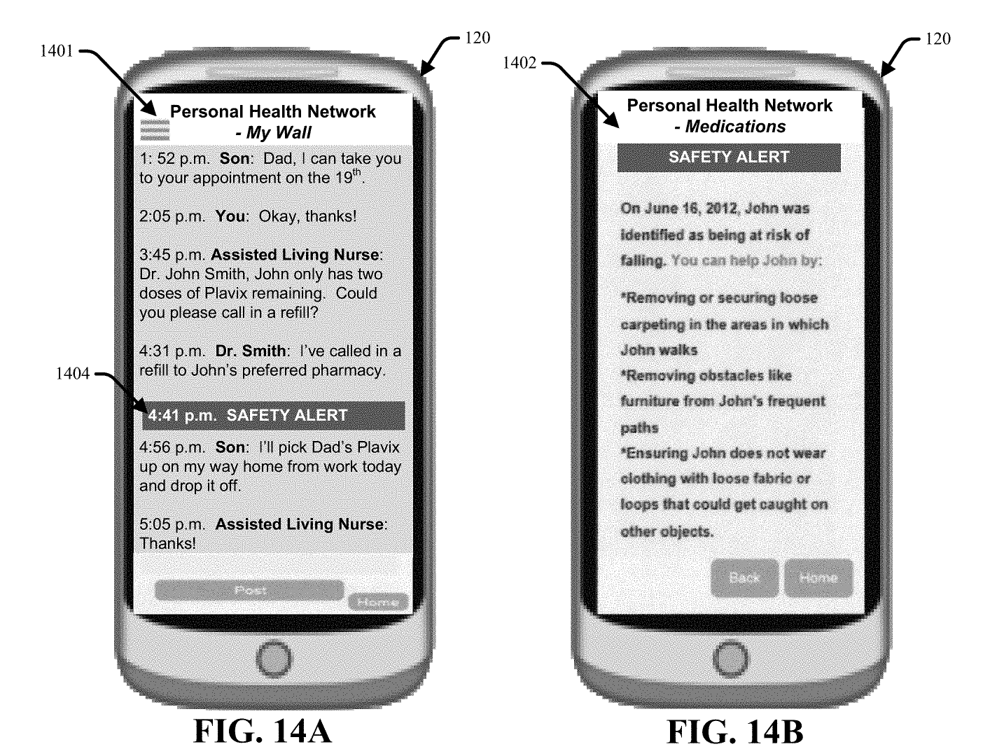

FIGS. 14A-B present example interfaces (interfaces 1401 and 1402) facilitated by the safety alert component 1302 of the example PHN system 100 in accordance with various embodiments described herein. In the embodiment shown, interfaces 1401 and 1402 are presented to the patient, which in this case is John Doe, in association with usage of the PHN application 122 and/or the PHN service provider 102 via his client device 120. Repetitive description of like elements employed in respective embodiments is omitted for sake of brevity.

With reference to FIG. 14A, interface 1401 provides an example representation of the patient's wall. Interface 1401, is similar to interface 701 shown in FIG. 7 with the addition of a “safety alert” 1404 that was received at 4:41 pm. The safety alert 1404 can be presented in bold font, highlighted, underlined or the like to draw attention thereto when posted on the patient's wall (or another suitable forum). The safety alert 1404 can further be selected directly from the patient's wall to view additional information regarding the safety alert.

For example, FIG. 14B presents an example interface 1402 generated in response to selection of the safety alert 1404 from interface 1401. The safety alert includes information identifying a safety concern issued for the patient and further provides information regarding how to alleviate the safety concern. In an embodiment, the safety alert 1404 is automatically generated by the electronic medical record system used by the patient's healthcare provider or other external sources/systems 134, and an existing network 136 interface transfers such safety alert into the patient's PHN with no human action required.

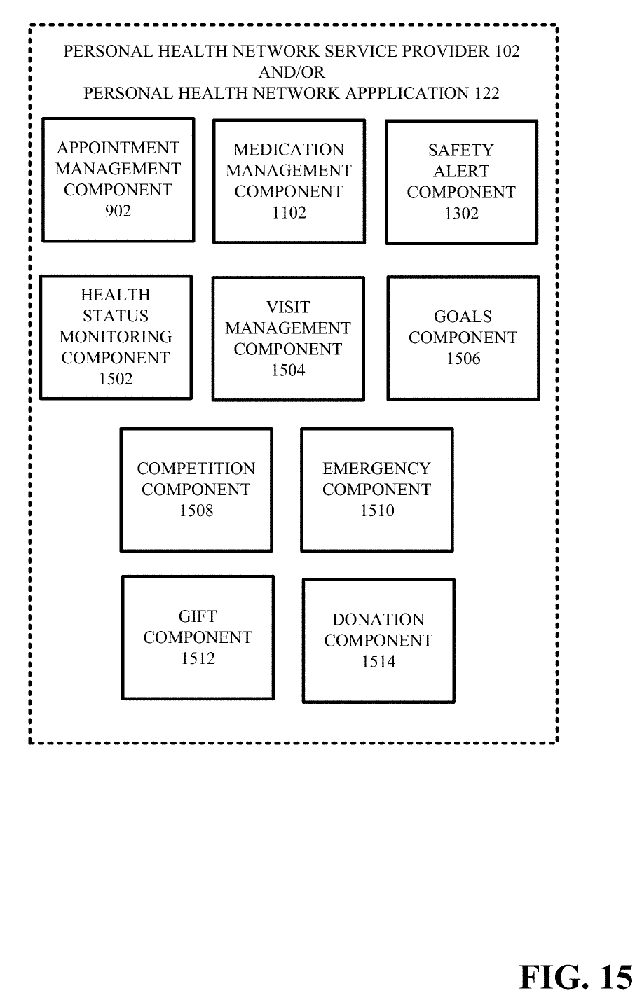

FIG. 15 presents various additional components that can be provided by the PHN service provider 102 and/or the PHN application 122 in accordance with various embodiments described herein. These components can include but are not limited to: health status monitoring component 1502, visit management component 1504, goals component 1506, competition component 1508, emergency component 1510, gift component 1512 and donation component 1515. With reference to FIGS. 1 and 15, in one embodiment of system 100, one or more of the additional components 1502-1514 can be provided at the PHN service provider 102 or the PHN application 122 of the client device 120. In another embodiment of system 100, various operations of the components 1502-1514 can be distributed between the PHN service provider 102 and the PHN application 122 of the client device 120. Accordingly, the additional components 1502-1504 are shown in a dashed box identified as PHN service provider 102 and/or PHN application 122 to indicate these different embodiments. Repetitive description of like elements employed in respective embodiments is omitted for sake of brevity.

In one or more embodiments, the health status monitoring component 1502 can facilitate monitoring the health status of the patient by the patient and one or more of the patient's PHN members (as authorized by the patient), based on physiological data received from one or more health monitoring devices worn by the patient. For example, the health status monitoring component 1502 can be configured to receive and process raw data captured from a health monitoring device worn by the patient and implanted into the patient to determine various health states of the patient in real-time. In other embodiments, the respective health monitoring devices can provide the health status monitoring component 1502 real-time information regarding the patient's health states (as determined by the respective health monitoring devices). In some embodiments, the health status monitoring component 1502 can be configured to post information regarding a patient's monitored health status to the patient's wall or a group message board for the patient and the respective members of the patient's PHN to see. In other embodiments, the health status monitoring component 1502 can post information regarding a patient's health status to respective members walls. For example, the health status monitoring component 1502 can be configured to post information regarding the patient's health status based on one or more characteristics of the patient's health status. For example, the health status monitoring component 1502 can be configured to post information identifying a current heart rate or blood pressure based on information indicating the patient's heart rate is too high or blood pressure is too low (e.g., with respect to defined thresholds for the patient).

The visit management component 1504 can provide a same similar mechanism employed by the appointment management component 902 to manage in person or webcast visits with the patient by respective members of the patient's PHN. For example, the visit management component 1504 can facilitate signing up respective members of the patient's PHN to attend in person or webcast patient visits. The visit management component 1504 can also provide the patient and respective members of the patient's PHN access to information regarding when visits are schedule, who is attending and how (e.g., in person or via webcast). In some embodiments, information regarding patient visits can be posted to the patient's wall, the group message board, and/or the individual walls of the respective members.

In addition, the visit management component 1504 can facilitate scheduling patient visits. For example, the visit management component 1504 can allow members of the patient's PHN to schedule in person and webcast visits with the patient. For instance the members can send the patient requests for visits and the patient can either accept or decline (or vice versa). In addition, the visit management component 1504 can allow the member(s) and/or the patient setting up the visit to open up the visit to other members (e.g., allow other members to sign up for attend the visit). In some embodiments, the visit management component 1504 can access information regarding the patient's schedule (e.g., scheduled appointments, scheduled procedures, sleep schedule, dining schedule, activity schedule, and the like) to facilitate scheduling patient visits at appropriate and available times. The visit management component 1504 can also access information regarding regulations associated with patient visits to facilitate scheduling patient visits in contexts where the patient is located at a healthcare facility or under the care of a healthcare service provider that implements regulations regarding patient visits. For example, such regulations can relate to authorized visiting times, who is authorized to visit (e.g., family members only, friends and family, immediate family, etc.), number of allowed patient visits, number of allowed visitors, and the like. In some embodiments, the visit management component 1504 can also provide the patient and the patients PHN members access to information regarding patient visit regulations. The visit management component 1504 can also post information regarding patient visit regulations to the patient's wall or the group message board when the patient is admitted to a particular healthcare service provider facility the implements visiting regulations and when the visit management component 1504 receives information regarding a change to the regulations. In some embodiments, the patient can also implement his or her own regulations regarding visits that can be applied by the visit management component (e.g., the patient can provide information indicating he or she is not feeling well and does not want visitors today).

The goals component 1506 can facilitate setting and tracking goals for the patient and/or the patient's PHN members. Information regarding the goals and progress toward achieving goals can further be shared with the patient and/or the patient's PHN members via the various mechanisms afforded by the server community connection component 118 and/or the client community connection component 126. For example, PHN application 122 can feature a page in which the patient may enter personal goals (e.g., “attend daughter's wedding in March,” or “lose 25 lbs.”). In another example, patient goal information can be received from healthcare service providers (e.g., various external sources/systems 134). For example, a patient's physical therapist may provide goal information that the patient is to attend physical therapy twice per week).

The competition component 1508 can facilitate competitions between the patient and other patients, the patient and the patient's PHN members, and respective PHN members. For example, the patient and/or the patients PHN may choose to create and/or participate in friendly competitions with each other based on self-entered health data or data drawn from other sources (e.g., external sources/systems 134, worn health monitoring devices, and the like). For example, the competition component 1508 can provide and mange a competition based on automated blood glucose measurements that are received for the competitors (e.g., via glucose monitoring devices worn by the competitors that are configured to measure and report glucose levels in real time). The competition function could allow, for example, the competitors to create a competition with each other for “most consecutive days of well-controlled blood sugar.” In an aspect, competition results can be tracked and posted to the respective competitors via the various mechanisms afforded by the server community connection component 118 and/or the client community connection component 126.

The emergency component 1510 can provide a mechanism via which the patient and/or the patient's PHN members can notify one another and/or an external emergency system/service provider regarding an emergency associated with the patient's healthcare for which the patient needs immediate medical attention. For example, the emergency component 1510 can provide an emergency button or icon that can be presented to the patient's and/or the patient's PHN members, wherein selection of the button results in sending of a notification to the respective members (e.g., at their respective client device 120) and/or an emergency service provider regarding the emergency.

The gift component 1512 can facilitate sending gifts to the patient and/or respective members of the patient's PHN. In one embodiment, the gift component 1512 can facilitate sending gifts to the patient (e.g., flowers, cards, balloons, gift baskets, etc.) at the patient's location. For example, in many scenarios, a friend, family member, etc. may not know where to send gifts, what gifts the patient is allowed to receive, how to send the gifts, etc. For instance, in a hospital setting, it may be difficult to get for the friends and family to find this information, especially in situations when the patient may be regularly moved to different areas and/or in situations when the patients health status is unstable and thus may result in dynamic changes to the patient's caregiver, location, treatment, etc. The gift component 1512 can have access to such information related to how, when, where, and what gifts to send, making it easy for friends and family members to select and send gifts to the patient. For example, in an aspect, the PHN application 122 can feature a “gift giving” function that allows a PHN member to select and purchase a gift to send to the patient. In some implementations, the gift giving function can automatically filter gift options based on information regarding what gifts the patient is authorized to receive, preferences of the patient (e.g., provided by the patient) regarding specific gifts or types of gifts the patient likes, gifts the patient has already received from other PHN members, and the like. Via the gift giving function, after a gift has been purchased, the PHN member can merely request the gift to be sent to the patient, and the PHN application 122 can take care of the rest. For example, the PHN application 122 can automatically arrange where, when and how to deliver the gift based on information accessible to the PHN application 122 regarding these parameters (e.g., hospital location, room number, attending nurse, hours, discharge date, etc.). In another example, the PHN application can automatically transmit approved gift requests to vendors (e.g., florists, gift basket vendors, etc.) that have interfaced their ordering systems to the PHN application 122.

In another embodiment, the gift component 1512 can facilitate sending gifts to the patient via the PHN. For example, the gift component 1512 can facilitate sending the patient ecards, gift cards, and the like via the PHN application 122. Similarly, the donation component 1514 can facilitate allowing PHN members to provide the patient a monetary donation to help the patient with medical care costs. For example, the donation component 1514 can set up a donation account and provide an interface via which PHN members can electronically donate to the patient's donation account. In some embodiments, the donation component 1514 can also post information regarding donations made by PHN members to the patient's wall, the group message board, and/or respective walls of the PHN members to recognize their charitable contributions in a public manner.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 16, a suitable environment 1600 for implementing various aspects of the claimed subject matter includes a computer 1602. The computer 1602 includes a processing unit 1604, a system memory 1606, a codec 1605, and a system bus 1608. The system bus 1608 couples system components including, but not limited to, the system memory 1606 to the processing unit 1604. The processing unit 1604 can be any of various available suitable processors. Dual microprocessors and other multiprocessor architectures also can be employed as the processing unit 1604.

The system bus 1608 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 16104), and Small Computer Systems Interface (SCSI).

The system memory 1606 includes volatile memory 1610 and non-volatile memory 1612. The basic input/output system (BIOS), containing the basic routines to transfer information between elements within the computer 1602, such as during start-up, is stored in non-volatile memory 1612. In addition, according to present innovations, codec 1605 may include at least one of an encoder or decoder, wherein the at least one of an encoder or decoder may consist of hardware, a combination of hardware and software, or software. Although, codec 1605 is depicted as a separate component, codec 1605 may be contained within non-volatile memory 1612. By way of illustration, and not limitation, non-volatile memory 1612 can include read only memory (ROM), programmable ROM (PROM), electrically programmable ROM (EPROM), electrically erasable programmable ROM (EEPROM), or flash memory. Volatile memory 1610 includes random access memory (RAM), which acts as external cache memory. According to present aspects, the volatile memory may store the write operation retry logic (not shown in FIG. 16) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1602 may also include removable/non-removable, volatile/non-volatile computer storage medium. FIG. 16 illustrates, for example, disk storage 1614. Disk storage 1614 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1614 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1614 to the system bus 1608, a removable or non-removable interface is typically used, such as interface 1616.

It is to be appreciated that FIG. 16 describes software that acts as an intermediary between users and the basic computer resources described in the suitable operating environment 1600. Such software includes an operating system 1618. Operating system 1618, which can be stored on disk storage 1614, acts to control and allocate resources of the computer system 1602. Applications 1620 take advantage of the management of resources by operating system 1618 through program modules 1624, and program data 1626, such as the boot/shutdown transaction table and the like, stored either in system memory 1606 or on disk storage 1614. It is to be appreciated that the claimed subject matter can be implemented with various operating systems or combinations of operating systems.

A user enters commands or information into the computer 1602 through input device(s) 1628. Input devices 1628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1604 through the system bus 1608 via interface port(s) 1630. Interface port(s) 1630 include, for example, a serial port, a parallel port, a game port, and a universal serial bus (USB). Output device(s) 1636 use some of the same type of ports as input device(s). Thus, for example, a USB port may be used to provide input to computer 1602, and to output information from computer 1602 to an output device 1636. Output adapter 1634 is provided to illustrate that there are some output devices 1636 like monitors, speakers, and printers, among other output devices 1636, which require special adapters. The output adapters 1634 include, by way of illustration and not limitation, video and sound cards that provide a means of connection between the output device 1636 and the system bus 1608. It should be noted that other devices and/or systems of devices provide both input and output capabilities such as remote computer(s) 1638.

Computer 1602 can operate in a networked environment using logical connections to one or more remote computers, such as remote computer(s) 1638. The remote computer(s) 1638 can be a personal computer, a server, a router, a network PC, a workstation, a microprocessor based appliance, a peer device, a smart phone, a tablet, or other network node, and typically includes many of the elements described relative to computer 1602. For purposes of brevity, only a memory storage device 1640 is illustrated with remote computer(s) 1638. Remote computer(s) 1638 is logically connected to computer 1602 through a network interface 1642 and then connected via communication connection(s) 1644. Network interface 1642 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1644 refers to the hardware/software employed to connect the network interface 1642 to the bus 1608. While communication connection 1644 is shown for illustrative clarity inside computer 1602, it can also be external to computer 1602. The hardware/software necessary for connection to the network interface 1642 includes, for exemplary purposes only, internal and external technologies such as, modems including regular telephone grade modems, cable modems and DSL modems, ISDN adapters, and wired and wireless Ethernet cards, hubs, and routers.

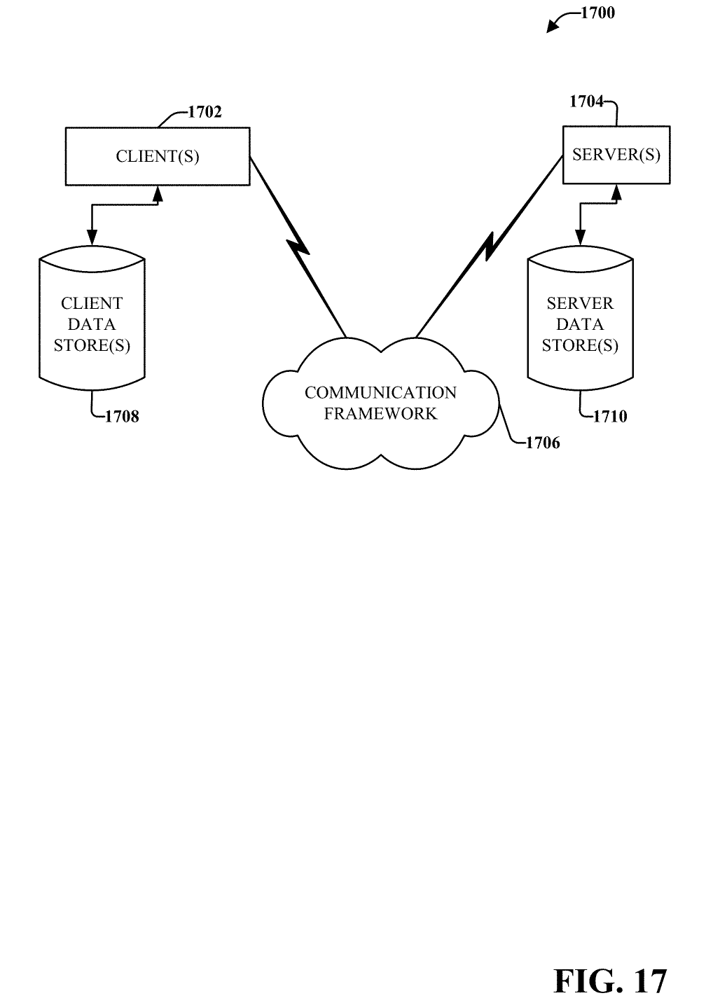

Referring now to FIG. 17, there is illustrated a schematic block diagram of a computing environment 1760 in accordance with this disclosure. The system 1760 includes one or more client(s) 1762 (e.g., laptops, smart phones, PDAs, media players, computers, portable electronic devices, tablets, and the like). The client(s) 1762 can be hardware and/or software (e.g., threads, processes, computing devices). The system 1760 also includes one or more server(s) 1764. The server(s) 1764 can also be hardware or hardware in combination with software (e.g., threads, processes, computing devices). The servers 1764 can house threads to perform transformations by employing aspects of this disclosure, for example. One possible communication between a client 1762 and a server 1764 can be in the form of a data packet transmitted between two or more computer processes wherein the data packet may include video data. The data packet can include a metadata, e.g., associated contextual information, for example. The system 1760 includes a communication framework 1766 (e.g., a global communication network such as the Internet, or mobile network(s)) that can be employed to facilitate communications between the client(s) 1762 and the server(s) 1764.

Communications can be facilitated via a wired (including optical fiber) and/or wireless technology. The client(s) 1762 include or are operatively connected to one or more client data store(s) 1768 that can be employed to store information local to the client(s) 1762 (e.g., associated contextual information). Similarly, the server(s) 1764 are operatively include or are operatively connected to one or more server data store(s) 1716 that can be employed to store information local to the servers 1764.

In one embodiment, a client 1762 can transfer an encoded file, in accordance with the disclosed subject matter, to server 1764. Server 1764 can store the file, decode the file, or transmit the file to another client 1762. It is to be appreciated, that a client 1762 can also transfer uncompressed file to a server 1764 and server 1764 can compress the file in accordance with the disclosed subject matter. Likewise, server 1764 can encode video information and transmit the information via communication framework 1766 to one or more clients 1762.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter. [Do we want to mention the possibility of the application being run as part of a cloud service, e.g., contracting the operation whole thing to Microsoft Azure or Amazon Web Services with no specific physical configuration?]

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

What is claimed is:

1. A system, comprising:
a memory that stores computer executable components;
a processor that executes computer executable components stored in the memory, wherein the computer executable components comprise:
an authorization component configured to receive authorization information indentifying one or more entities that a patient authorizes for inclusion in a personal health network of the patient;
an access component configured to provide the one or more entities access to healthcare information regarding healthcare of the patient via respective devices of the one or more entities based on inclusion of the one or more entities in the personal health network of the patient, wherein the access component further provides the patient access to the healthcare information via a patient device of the patient; and
a connection component configured to facilitate communication between the one or more entities and the patient regarding the healthcare of the patient via the respective devices of the one or more entities and the patient device based on inclusion of the one or more entities in the personal health network of the patient.

2. The system of claim 1, further comprising:
a reception component configured to receive the healthcare information from one or more healthcare information sources via a network; and
a posting component configured to post the healthcare information to a group messaging forum, wherein the access component is configured to provide the one or more entities and the patient access to the group messaging forum via the respective devices and the patient device based on inclusion of the one or more entities in the personal health network.

3. The system of claim 1, wherein the connection component comprises:
a reception component configured to receive information from the one or more entities via the respective devices regarding the healthcare of the patient; and
a posting component configured to post the information to a group messaging forum, wherein the access component is configured to provide the one or more entities and the patient access to the group messaging forum via the respective devices and the patient device based on inclusion of the one or more entities in the personal health network.

4. The system of claim 1, wherein the connection component comprises:
a reception component configured to receive information from the one or more entities via the respective devices regarding the healthcare of the patient; and
a posting component configured to post the information to information feeds associated with respective profiles of the one or more entities, wherein access component is configured to provide the one or more entities and the patient access to the information feeds via the respective devices and the patient device based on inclusion of the one or more entities in the personal health network.

5. The system of claim 1, further comprising:
a reception component configured to receive information from a first entity of the one or more entities via a first device of the respective devices regarding the healthcare of the patient; and
an account component configured to associate the information with first profile information of the first identity, wherein the access component is configured to provide the one or more entities and the patient access to the profile information based on inclusion of the one or more entities in the personal health network.

6. The system of claim 1, wherein the connection component comprises:
a private messaging component that facilitates sending private electronic messages between the one or more entities and the patient via the respective devices and the patient device.

7. The system of claim 1, wherein the healthcare information comprises appointment information regarding healthcare appointments of the patient, the system further comprising:
an appointment component configured to manage attendance of the patient and the one or more entities to the healthcare appointments.

8. The system of claim 7, wherein the attendance component is configured facilitate registering the one or more entities to attend the healthcare appointments and generate attendance information regarding who is registered to attend the healthcare appointments, wherein the access component is configured to provide the one or more entities and the patient access to the attendance information based on inclusion of the one or more entities in the personal health network.

9. The system of claim 7, wherein the attendance component is further configured to generate notifications regarding who is registered to attend the healthcare appointments and send the notifications to the patient via the patient device.

10. The system of claim 7, wherein the attendance component is further configured to facilitate videoconferencing between the one or more entities and the patient during the appointments.

11. The system of claim 1, wherein the healthcare information comprises medication information regarding a medication regimen followed by the patient, the system further comprising:
a medication component configured to generate the medication information based on reception of information from the patient device indicating when the patient has taken medication and associate the medication information with profile information associated with the patient, wherein the access component is configured to provide the one or more entities access to the profile information based on inclusion of the one or more entities in the personal health network.

12. The system of claim 11, wherein the medication component is further configured to determine when the patient has not taken a medication according to the medication regimen, generate a notification regarding failure of the patient to take the medication according to the mediation regime, and send the notification to the patient via the patient device.

13. The system of claim 11, wherein the medication component is further configured to determine when the patient has not taken a medication according to the medication regimen, generate a notification regarding failure of the patient to take the medication according to the mediation regime, and send the notification to the one or more entities via the respective devices.

14. The system of claim 1, further comprising:
an interface component configured to generate a interface that facilitates the access to the healthcare information and the communication between the one or more entities via the respective devices of the one or more entities and the patient device.

15. A computer implemented method, comprising:
receiving, by a system comprising a processor, authorization information indentifying one or more entities that a patient authorizes for inclusion in a personal health network of the patient;
providing, by the system, the one or more entities access to healthcare information regarding healthcare of the patient via respective devices of the one or more entities based on inclusion of the one or more entities in the personal health network of the patient, wherein the access component further provides the patient access to the healthcare information via a patient device of the patient; and
facilitating, by the system, communication between the one or more entities and the patient regarding the healthcare of the patient via the respective devices of the one or more entities and the patient device based on inclusion of the one or more entities in the personal health network of the patient.

16. The computer implemented method of claim 15, further comprising:
receiving, by the system, the healthcare information from one or more healthcare information sources via a network; and
posting, by the system, the healthcare information to a group messaging forum, wherein the access component is configured to provide the one or more entities and the patient access to the group messaging forum via the respective devices and the patient device based on inclusion of the one or more entities in the personal health network.

17. The computer implemented method of claim 15, further comprising:
receiving, by the system, information from the one or more entities via the respective devices regarding the healthcare of the patient; and
posting, by the system, the information to a group messaging forum, wherein the access component is configured to provide the one or more entities and the patient access to the group messaging forum via the respective devices and the patient device based on inclusion of the one or more entities in the personal health network.

18. The computer implemented method of claim 15, further comprising:
receiving, by the system, information from the one or more entities via the respective devices regarding the healthcare of the patient; and
posting, by the system, the information to information feeds associated with respective profiles of the one or more entities, wherein access component is configured to provide the one or more entities and the patient access to the information feeds via the respective devices and the patient device based on inclusion of the one or more entities in the personal health network.

19. A tangible computer-readable storage medium comprising computer-readable instructions that, in response to execution, cause a computing system to perform operations, comprising:
receiving authorization information indentifying one or more entities that a patient authorizes for inclusion in a personal health network of the patient;
providing the one or more entities access to healthcare information regarding healthcare of the patient via respective devices of the one or more entities based on inclusion of the one or more entities in the personal health network of the patient, wherein the access component further provides the patient access to the healthcare information via a patient device of the patient; and
facilitating communication between the one or more entities and the patient regarding the healthcare of the patient via the respective devices of the one or more entities and the patient device based on inclusion of the one or more entities in the personal health network of the patient.

20. The tangible computer-readable storage medium of claim 19, wherein the operations further comprise:
receiving the healthcare information from one or more healthcare information sources via a network; and
posting the healthcare information to a group messaging forum, wherein the access component is configured to provide the one or more entities and the patient access to the group messaging forum via the respective devices and the patient device based on inclusion of the one or more entities in the personal health network.
